(19) United States
(12) Patent Application Publication
(10) Pub. No.: US 2025/0083372 A1
(43) Pub. Date: Mar. 13, 2025

(54) PERIODIC EXTENSIONAL FLOW REACTOR

(71) Applicants: Northeastern University, Boston, MA (US); United States Army Research Laboratory, Durham, NC (US)

(72) Inventors: Steven Raymond Lustig, Attleboro, MA (US); John J.S. Biswakarma, Boston, MA (US); Emil J. Sandoz-Rosado, Aberdeen Proving Ground, MD (US); Andrew George Carr, Swampscott, MA (US); Eric Dean Wetzel, Bel Air, MD (US)

(21) Appl. No.: 18/828,513

(22) Filed: Sep. 9, 2024

Related U.S. Application Data
(60) Provisional application No. 63/552,376, filed on Feb. 12, 2024.
(60) Provisional application No. 63/537,234, filed on Sep. 8, 2023.

(51) Int. Cl. B29C 48/08; B29C 48/14; B29C 48/30; B29L 7/00

(52) U.S. Cl. CPC B29C 48/08; B29C 48/14; B29C 48/302; B29K 2995/005; B29L 2007/008

(57) ABSTRACT

An apparatus and method for producing oriented polymer films are disclosed. The apparatus includes a curved enclosure configured to rotate and a flow obstacle. The curved enclosure has an interior volume with an opening at one end. The flow obstacle extends through the opening and interior volume, with one end rigidly coupled to a mounting plate. The flow obstacle's position is adjustable to contact the interior surface of the curved enclosure, defining a gap between them. The method involves introducing a material into the curved enclosure, adjusting the flow obstacle's position, and rotating the curved enclosure to generate an extensional flow within the material. The apparatus and method may be used for producing two-dimensional polymer films and can incorporate features such as inert gas flushing, heating systems, and various blade configurations for the flow obstacle.

### CROSS REFERENCE TO RELATED APPLICATIONS

This application claims the benefit of priority to U.S. Provisional Patent Application No. 63/552,376, filed Feb. 12, 2024; and U.S. Provisional Patent Application No. 63/537,234, filed Sep. 8, 2023. The entire contents of each are hereby incorporated by reference.

### STATEMENT AS TO FEDERALLY SPONSORED RESEARCH

This invention was made with Government support under W911NF-20-2-0024 awarded by the United States Army Research Laboratory. The Government has certain rights in the invention.

### BACKGROUND

### Field of the Disclosed Subject Matter

The disclosed subject matter relates to systems and methods to produce oriented films. Particularly, the present disclosed subject matter is directed to periodic extensional flow reactor systems.

### Description of Related Art

It is a common technological need to produce polymer films in which the polymer orientation is strongly anisotropic, that is, particularly oriented in one direction within the plane of the film. Common technologies to achieve oriented films include spin coating, flow coating, doctor blade coating, and extrusion coating. The polymer exists in these processes either as a melt or a fluid solution mixture. In all these technologies the polymer material experiences a single occurrence of extensional flow to orient the macromolecules before they are rendered immobile by either drying, solidification, or crystallization. Such technologies achieve orientation by subjecting the polymer to an extensional flow, this requires flow through a contraction. Once the material thickness equals the smallest contraction dimension, the material can no longer experience further extensional flow. Afterward, the polymer orientation can only be improved through additional stretching, rolling, or similar processes. These extensional flow technologies operate on time scales much shorter than the time scales required to polymerize the macromolecules. As a result, these technologies are restricted to be used only after the polymer has reached sufficient polymerization and size growth. Moreover, these technologies are not amenable to be applied repeatedly to a polymer, particularly while the polymer is growing in size from its small, low molecular weight monomers.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes an apparatus for producing oriented polymer films comprises a curved enclosure having an exterior surface and an interior surface defining an interior volume and a flow obstacle having a first end and a second end. An opening extends through the curved enclosure and into the interior volume. The curved enclosure is configured to rotate. The second end of the flow obstacle extends through the opening and within the interior volume of the curved enclosure and the first end of the flow obstacle is rigidly coupled to a mounting plate. A position (e.g., x-, y-, z-position, and/or angle of the flow obstacle) of the flow obstacle is adjustable so that the flow obstacle contacts the interior surface of the curved enclosure. A gap is defined between the interior surface of the curved enclosure and the flow obstacle, where a material is disposed. The curved enclosure may be flushed with inert gas (e.g., nitrogen). The curved enclosure may comprise a heat transfer system including an insulator, a conductor, and a layer for heating, cooling, or a combination thereof. The material may be a two-dimensional polymer. The material may be any other type of polymer. The material may be a phase changing system, a reacting system, or a combination thereof that produces a polymer. A continuous rotation of the curved enclosure may generate a periodic extensional flow within the material. The curved enclosure may be a cylindrical enclosure. The internal flow obstacle may comprise a blade support arm connected to a blade. The blade may be a flap blade, a cylindrical blade, or any other shaped blade. The blade may be fixedly coupled to the blade support arm. The blade may be rotatably coupled to the blade support arm so that the blade rotates in response to a rotation of the curved enclosure. An extensional flow may be generated in the material. A shear flow may be generated in the material. There may be a plurality of flows generated in the material that may be laminar, turbulent, or a combination thereof. The blade may be a plurality of blades. The mounting plate can include a tip-tilt base plate, a translation stage, or a combination thereof.

The disclosed subject matter includes an apparatus for producing oriented polymer films comprising a curved enclosure having a surface and a flow obstacle having a first end and a second end. The second end of the flow obstacle extends over the surface of the curved enclosure and the first end of the flow obstacle is rigidly coupled to a mounting plate. A position of the flow obstacle is adjustable so that the flow obstacle contacts the surface of the curved enclosure. A gap is defined between the surface of the curved enclosure and the flow obstacle, where a material is disposed.

The disclosed subject matter also includes a method of producing anisotropic polymer films involves introducing a material into the curved enclosure, adjusting the position of the flow obstacle to contact the interior surface, and rotating the curved enclosure to generate an extensional flow within the material. A gap is defined between the interior surface of the curved enclosure and the flow obstacle, where the material is disposed.

The method may include additional steps such as injecting the material into the curved enclosure, introducing a two-dimensional polymer, rotating the curved enclosure such that material undergoes periodic extensional flow, flushing with inert gas (e.g., nitrogen), and/or rotating a portion of the flow obstacle in response to the rotation of the curved enclosure. The blade of the flow obstacle may be a cylindrical blade.

The disclosed subject matter also includes an apparatus for producing oriented polymer films, comprising a curved enclosure having a surface and a flow obstacle having a first end and a second end. The flow obstacle extends over the surface of the curved enclosure and the first end and second end of the flow obstacle are rigidly coupled to a mounting plate. A position of the flow obstacle is adjustable so that the flow obstacle contacts the surface of the curved enclosure. A gap is defined between the surface of the curved enclosure and the flow obstacle, where a material is disposed.

The disclosed subject matter also includes an apparatus for producing oriented polymer films, comprising a curved enclosure having a surface and a flow obstacle having a first end and a second end. The flow obstacle extends over the surface of the curved enclosure and the first end and second end of the flow obstacle each rigidly coupled to a mounting plate. A position of the flow obstacle is adjustable. A gap is defined between the surface of the curved enclosure and the flow obstacle, where a material is disposed.

The curved enclosure can rotate. The blade can be a plurality of blades. The mounting plate can include a tip-tilt base plate, a translation stage, or a combination thereof.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and implementations of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more implementation(s) or example(s) of the present subject matter in whole or in part.

FIG. 1A shows a first implementation of a periodic extensional flow reactor (PEFR).

FIGS. 1B-1C show close-up views of the periodic extensional flow reactor shown in FIG. 1A.

FIG. 2A-2B shows cross-sectional views of an implementation of a blade in a flap configuration.

FIG. 2C shows a close-up view of the cross-sectional view shown in FIG. 2B.

FIG. 2D shows a perspective view of an implementation of a cap holding a blade support arm.

FIG. 3A-3B show various views of portions of the first implementation of a periodic extensional flow reactor.

FIG. 4 shows a view of an implementation of a stopper.

FIG. 5A shows a perspective view of an implementation of a blade support arm.

FIG. 5B shows a dashed line top view of an implementation of a blade support arm.

FIG. 5C shows a cross-sectional view of an implementation of a blade support arm.

FIG. 6 shows a cross-sectional view of an implementation of a heat transfer system for an enclosure.

FIG. 7A shows an exploded view of a second implementation of a periodic extensional flow reactor.

FIGS. 7B-7F show various close-up views of the periodic extensional flow reactor shown in FIG. 7A.

FIGS. 8A-8B show cross-sectional views of an implementation of a blade in a roller configuration.

FIG. 9A shows a side view of an implementation of a portion of a periodic extensional flow reactor.

FIGS. 9B-9C show cross-sectional views of the portion of the periodic extensional flow reactor shown in FIG. 9A.

FIG. 9D shows a front view of an implementation of a bearing plug.

FIG. 9E shows a side view of an implementation of the bearing plug shown in FIG. 9D.

FIG. 10A shows a side view of an implementation of a portion of a periodic extensional flow reactor.

FIG. 10B shows a front view of an implementation of an internal support.

FIG. 10C shows a side view of an implementation of an internal support.

FIG. 11A shows a side view of the portion of a periodic extensional flow reactor shown in FIG. 10A inserted in an enclosure of a periodic extensional flow reactor.

FIG. 11B shows a cross-sectional view of the portion of a periodic extensional flow reactor shown in FIG. 10A inserted in an enclosure of a periodic extensional flow reactor.

FIG. 11C shows a side view of the portion of a periodic extensional flow reactor shown in FIG. 10A aligned within an enclosure of a periodic extensional flow reactor.

FIG. 11D shows a cross-sectional view of the portion of a periodic extensional flow reactor shown in FIG. 10A aligned within an enclosure of a periodic extensional flow reactor.

FIG. 12 shows a side view of an implementation of a portion of a periodic extensional flow reactor.

FIGS. 13A-13B show images of a portion of a first implementation of a periodic extensional flow reactor.

FIGS. 14A-25 show images of different portions of a second implementation of a periodic extensional flow reactor.

FIGS. 26A-26D show TAPB-PDA films processed using a periodic extensional flow reactor.

FIG. 27 is a flow chart depicting a method for producing anisotropic polymer films.

### DETAILED DESCRIPTION

Reference will now be made in detail to exemplary implementations of the disclosed subject matter, an example of which is illustrated in the accompanying drawings. The method and corresponding steps of the disclosed subject matter will be described in conjunction with the detailed description of the system.

The disclosed subject matter can provide systems and methods for processing polymers to produce anisotropic films. The systems and/or methods can generate a controlled extensional flow. Extensional flow can include flows where a material (e.g., 2-dimensional polymer, any other type of polymer) is stretched and/or elongated. Extensional flows can be applied to materials such as polymers and liquid crystalline materials, which respond to extensional flow conditions. These conditions can include alignment and/or orientation of macromolecules within the material. The systems and/or methods can generate a controlled shear flow. Shear flow can include flows where a material (e.g., 2-dimensional polymer, any other type of polymer) is sheared. There can be a combination of shear flow and extensional flow generated in the material. There may be a plurality of flows generated in the material that may be laminar, turbulent, or a combination thereof. For example, each of the flows of the plurality may be laminar. In another example, each of the flows of the plurality may be different from each other (i.e., some may be laminar flows and others may be turbulent).

The systems and/or methods can orient polymers to form polymer films with specific directional properties (e.g., mechanical, optical, thermal, electrical, barrier, surface properties). Directional properties can arise from an orientation and/or orientation of polymer chains within the film, which can affect the film's physical and chemical characteristics. Polymer films can have higher strength along the direction of polymer alignment which can make them stronger and more resistant to stretching in that direction. The elasticity and/or flexibility of the polymer film can be modified based on the direction of polymer chain alignment. The optical properties of polymer films can be tailored. Polymer films can exhibit different optical properties depending on the direction of light passing through it. Polymer films can exhibit birefringence, exhibiting different refractive indices along different directions. Polymer films can be formed to polarize light in specific directions depending on the direction of polymer chain alignment. Polymer films can be formed to have directionally dependent thermal properties. The alignment of polymer chains can affect how heat is conducted through the polymer film. For example, heat can be conducted more effectively in the direction of polymer alignment. The direction of polymer alignment can influence how the polymer film expands and/or contracts with temperature changes. In conductive polymers, alignment of polymer chains can affect electrical conductivity. For example, polymer films can be created to have a higher conductivity in the direction of chain alignment. Polymer films can be formed to have directionally dependent barrier properties. For example, the alignment of polymer chains can influence the permeability of the film to gases and/or liquids. For example, the polymer film may be more or less permeable depending on the direction relative to the polymer alignment. Polymer films can be formed to have directionally dependent surface properties. The surface texture and frictional properties can be directional which can affect how the polymer film interacts with other surfaces and/or materials.

The disclosed subject matter can include a system configured to generate a periodic extensional flow between an enclosure and a flow obstacle (e.g., a blade) extending within the enclosure. A periodic extensional flow can be used to control the extent and type of stretching experienced by the material. The flow obstacle can be positioned non-concentrically within the enclosure. There can be a periodic, relative rotational displacement between the enclosure and flow obstacle. The enclosure can include an exterior surface and an interior surface defining an interior volume. The enclosure can comprise a curved surface (e.g., circular). Material can be removed from within the enclosure. A drain can be disposed within the enclosure to remove material. The drain can have a closed configuration so that the enclosure maintains a constant fluid volume. The drain can have an open configuration so that fluid can drain under gravity or the use of other forces, such as a pump or other suction mechanisms. Draining or removing fluid from the enclosure may be necessary to maintain specific operating conditions, manage fluid volume, or ensure proper processing. For example, excess fluid or by-products may be removed. The system can comprise a flow obstacle that wipes the interior surface of the supporting enclosure. The enclosure can rotate either continuously, periodically, or alternate between continuous and periodic rotation. The flow obstacle can include a blade which can be a flexible blade or a rigid blade that contacts a surface of the enclosure. The relative motion between a curvature of the enclosure and the flow obstacle can generate a periodically repeating extensional flow that orients polymers. Polymers can be oriented into an anisotropic film.

The disclosed subject matter can provide systems and methods for processing liquid crystalline liquids, liquid crystalline polymers, and liquid crystalline polymer solutions with anisotropic macromolecular orientation. The material introduced into the enclosure may be a reacting and/or phase changing system that produces a polymer. The material introduced into the enclosure can include a fluid material. The fluid material may react within the enclosure. The fluid material may become an oriented liquid crystal within the supporting enclosure.

The disclosed subject matter can include systems that can generate a periodically repeating extensional flow that orients polymers into an anisotropic film. A periodically repeating extensional flow can be applied continuously or repeatedly to a fluid solution or melt to improve the degree of polymer orientation until a desired anisotropy is attained. The periodically repeating extensional flow can be applied to low molecular weight monomers that are dynamically reacting and forming orientable macromolecules. A continuously periodic extensional flow can be applied sequentially to multiple layers of anisotropic polymer compositions. In some implementations, the systems and/or methods can be applied in a closed system configuration, where there is no change in total mass of the material. In some implementations, the systems and/or methods can be applied in an open system configuration, which enables a change in mass of the material.

The disclosed subject matter may be used in the production of high-performance, high strength, low-dielectric polymer films, unidirectional plates and cylinders. The disclosed subject matter may be employed in the production of electronic substrates, electronic components, and sensors; battery separators; transparent conductors; and photovoltaics. The disclosed subject matter may be used in the polymerization of 2-dimensional polymers, production of liquid crystalline state in solutions of 2-dimensional polymers, and/or production of oriented films of 2-dimensional polymers.

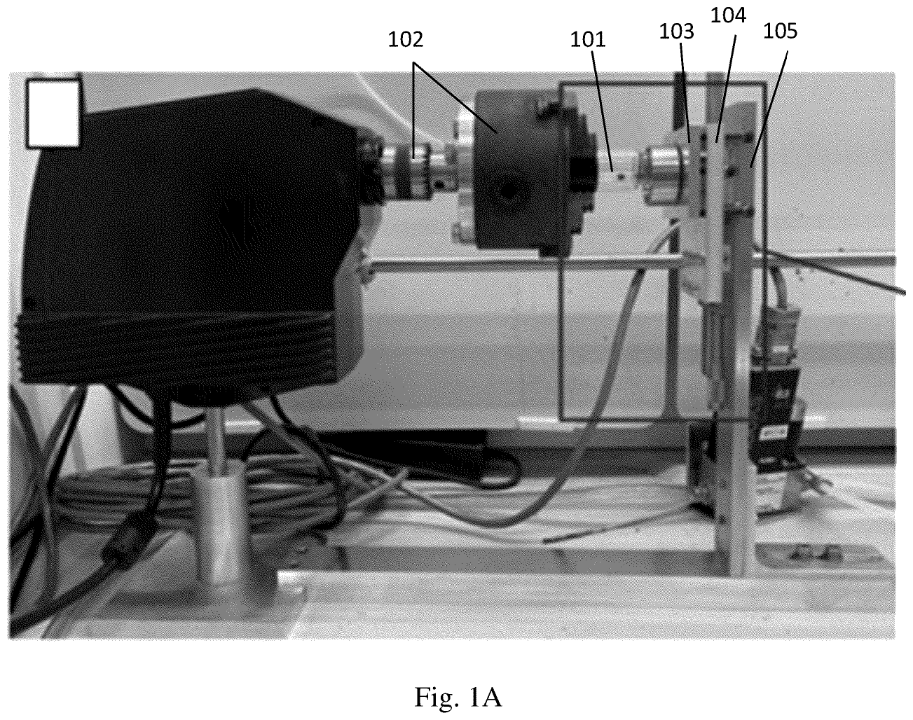

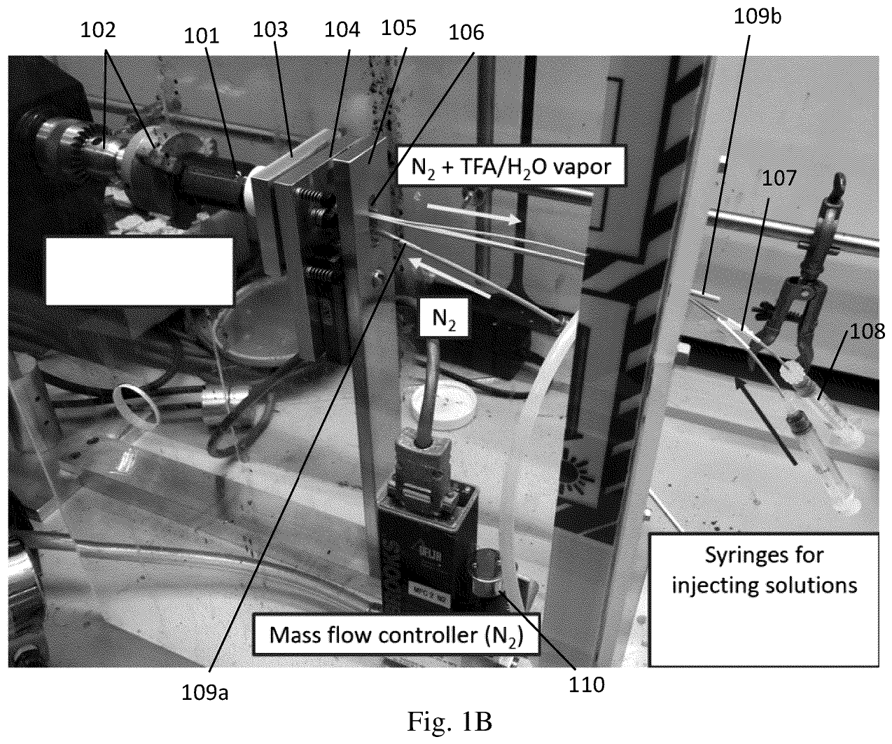

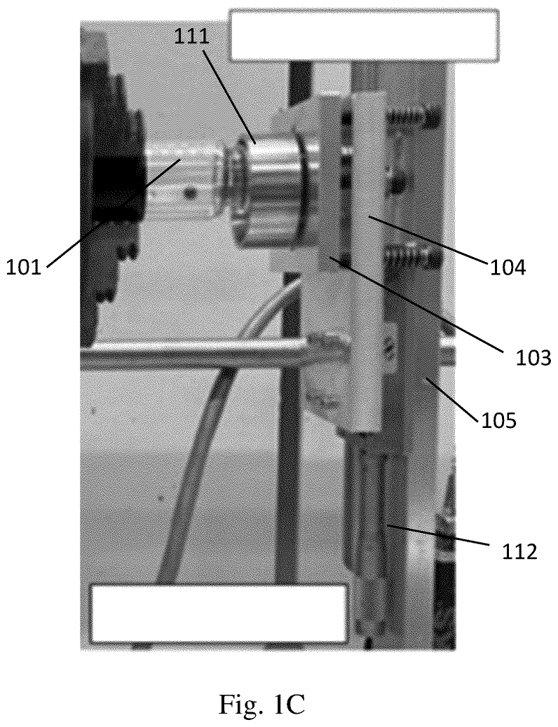

Referring now to FIG. 1A, and in brief overview, and with additional reference to FIGS. 1B-1C, views of a first implementation of a periodic extensional flow reactor are shown that include an enclosure 101, a rotator chuck assembly 102, a first mounting plate 103, a tip-tilt base plate 104, a second mounting plate 105. The periodic extensional flow reactor can be configured to generate an extensional flow within a material (e.g., 2-dimensional polymer solution, any other type of polymer solution). The rotator chuck assembly 102 can include a chuck, a rotating mechanism, an adapter plate, a spindle, bearings, a drive mechanism, a clamping mechanism, a control system, a lubrication system, a heating system and/or a cooling system. The rotator chuck assembly 102 can be configured to hold and rotate the enclosure 101. The enclosure 101 can rotate about its longitudinal axis. The tip-tilt base plate 104 can be disposed between the first mounting plate 103 and the second mounting plate 105. The second mounting plate 105 can be coupled (e.g., fixedly coupled) to a base. The second mounting plate 105 can be formed of a material with a high stiffness (e.g., modulus of aluminum, glassy plastic, steel, stainless steel) which can reduce deflection during loading. In this way, the second mounting plate 105 can, for example, support the load of the tip-tilt base plate 104 and the first mounting plate 103. The second mounting plate 105 can have a slot 106, which may be an opening that extends through the thickness of the second mounting plate 105. Tubing 107 may include one or more tubes that can each be routed through the slot 106. A first end of each of the tubing 107 can include an outlet in fluid communication with the inside of the enclosure 101. A syringe 108 can be connected at a second end of each of the tubing 107, where the second end includes an inlet. The syringe 108 can be configured to inject materials (e.g., reactants, fluids, solvents, 2-dimensional polymers, any type of polymer and/or additives) through the tubing 107 and into the enclosure 101. In some implementations, a flow control mechanism such as a pump, valve, and/or flow sensor can be attached to the tubing 107 and/or syringe 108 to control and/or modulate the flow of material (e.g., reactants, fluids, solvents, 2-dimensional polymers, any type of polymer, and/or additives) into the enclosure 101. Tubing 109a and 109b can be routed through the slot 106. A first end of the tubing 109a can include an outlet in fluid communication with the inside of the enclosure 101 and a second end of the tubing 109a can include an inlet that can be connected to a gas source such that a gas (e.g., inert gas, reactive gas, solvent vapor, and/or a combination of gases) can be flowed through the tubing 109a and into the enclosure 101. In some implementations, the inert gas is nitrogen gas. The inert gas used may be depend on the specific needs of the chemical reactions performed in the enclosure 101. The second end of the tubing 109a can be connected to a mass flow controller 110 to regulate the flow of gas.

A first end of the tubing 109b can include an inlet in fluid communication with the inside of the enclosure 101 and a second end of the tubing 109b can include an outlet in fluid communication with the exterior of the enclosure 101 (e.g., ambient environment). The tubing 109b can provide an outlet for gases (e.g., nitrogen gas, trifluoracetic acid (TFA) mixed with water vapor) which can help maintain the proper chemical environment, manage pressure, remove by-products from within the enclosure 101. In some implementations, the tubing (e.g., 107, 109a, 109b) can be flexible tubing or rigid tubing. In some implementations, the tubing (e.g., 107, 109a, 109b) can be formed from materials including, but not limited to, silicone, rubber, polyurethane, polycarbonate, acrylic, and/or metal. In some implementations, the tubing 109a and/or 109b have an ⅛″ outer diameter. In some implementations, the tubing 107 has an ⅛″ outer diameter.

The rotator chuck assembly 102 can include a chuck that grips and holds the enclosure 101. The chuck can be, for example, a three-jaw chuck or a four-jaw chuck. The chuck can be various sizes and configurations to accommodate the geometry of the enclosure 101. The rotator chuck assembly 102 can include a rotating mechanism which can include a rotator that is configured to provide a rotational motion to the chuck. The rotator can be a motor, a gearbox, or rotary actuator. The rotator chuck assembly 102 can include an adapter plate that connects the chuck to the rotating mechanism. The adapter plate can include holes and/or slots for attaching the chuck securely and aligning it with the rotator. The chuck can include attachment points that correspond to the holes and/or slots of the adapter plate. In some implementations, the rotator chuck assembly 102 can include a spindle for transferring a rotational motion from the rotator to the chuck. In some implementations, the rotator chuck assembly 102 can include bearings. For example, bearings can be used to support the spindle which can allow the spindle to rotate smoothly, help reduce friction, and/or maintain alignment of the components of the rotator chuck assembly 102. A drive mechanism of the rotator chuck assembly 102 may include gears, belts, and/or chains. The drive mechanism may control rotation speed and torque and can transmit a rotational force from the rotating mechanism to the spindle and chuck. In some implementations, the rotator chuck assembly 102 can include a clamping mechanism to secure the chuck in place and/or adjust the position of the chuck. The clamping mechanism may be manual or automated. The rotator chuck assembly 102 can include a control system (e.g., variable speed drive, programmable controller) for controlling the rotation speed, direction of rotation, and other parameters. In some implementations, the rotator chuck assembly 102 includes a cooling system (e.g., air cooling, ventilation, heat sink, liquid cooling). In some implementations, the rotator chuck assembly 102 includes a lubrication system which can help reduce wear on components. The rotator chuck assembly 102 can include a torque meter, a rotation rate meter, power meter, and/or temperature meter.

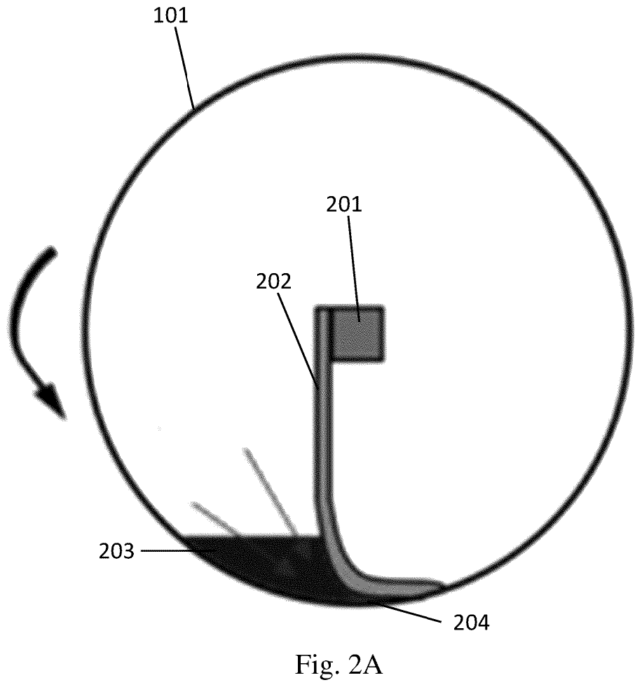

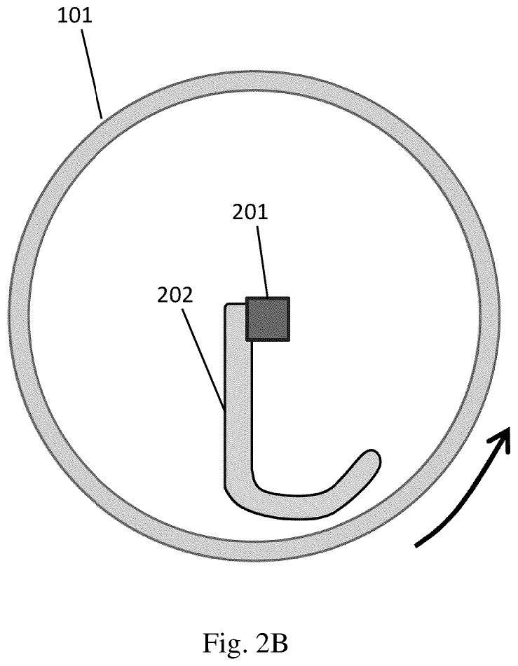

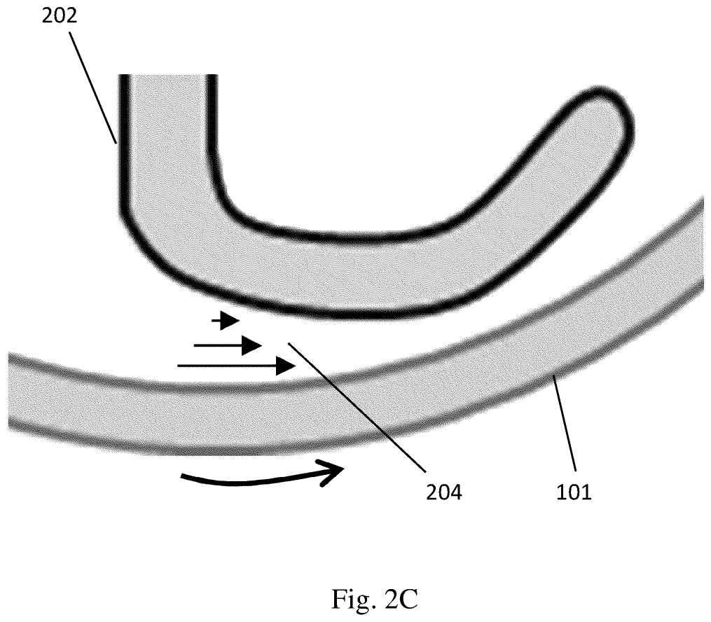

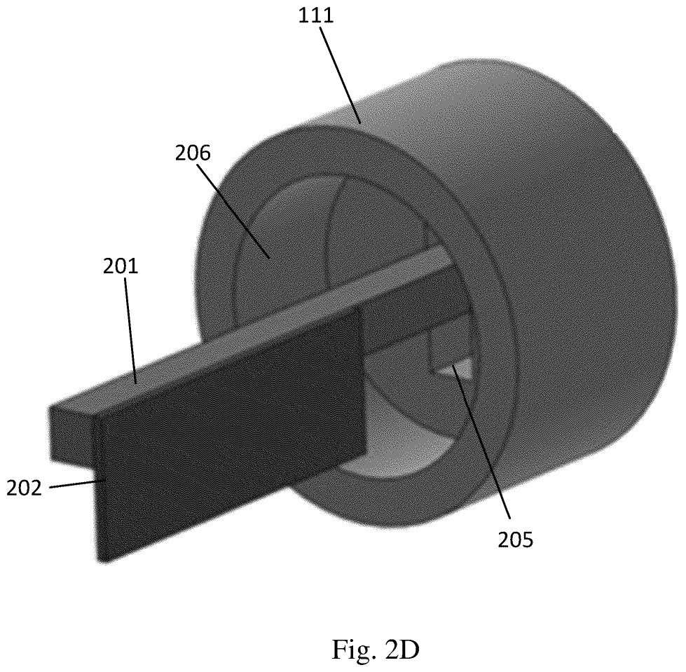

Still referring to FIGS. 1A-1C, and in greater detail, and with additional reference to FIGS. 2A-2D, various views of an enclosure 101 of a first implementation of a periodic extensional flow reactor are shown. FIGS. 2A and 2B show cross-sectional views of an implementation of an enclosure 101 for processing a material. FIG. 2D shows a perspective view of an implementation of a cap 111 for an enclosure 101. The cap 111 may be substantially cylindrical in shape with a recess 206 that can be sized and shaped to receive a portion of the enclosure 101 and to form a seal on the enclosure 101. In some implementations, the cap 111 is formed of metal (e.g., stainless steel, titanium). In some implementations, the cap 111 includes a sealing gasket, O-ring, foam liner, and/or compression seal. In some implementations, the cap 111 includes internal threads within the recess 206 and the enclosure 101 includes corresponding external threads. This threading configuration allows the cap 111 to be threadably coupled with the enclosure 101. In some implementations, the cap 111 and enclosure 101 include a snap-fit mechanism. For example, the cap 111 can include tabs or ridges that fit into a corresponding groove or recess in the enclosure 101.

The enclosure 101 can include an exterior surface and an interior surface defining an interior volume. The interior surface and/or exterior surface can be a curved surface (e.g., circular cross section). The enclosure 101 may be substantially cylindrical in shape. The enclosure 101 may be formed of materials including, but not limited to, glass (e.g., borosilicate glass, quartz glass), plastic (e.g., polycarbonate, polytetrafluoroethylene, polyethylene, polypropylene, polymethyl methacrylate), metal (e.g., stainless steel, titanium), and/or high-temperature ceramics. A flow obstacle, which can include a blade support arm 201 and blade 202, may extend into the interior volume of the enclosure 101. The blade support arm 201 can be a rigid member having a first end, a second end, and a thickness therebetween. A first end of the blade support arm 201 may be secured in place (e.g., rigidly coupled) between the cap 111 and the first mounting plate 103. The cap 111 can include a slot 205, which may be an opening that extends through the thickness of the cap 111. The portion of the blade support arm 201 can extend through the slot 205 of the cap 111. Tubing (e.g., tubing 107, 109a, 109b) can be routed through the slot 205. The slot 205 can be different shapes including circular, rectangular, polygonal, or irregularly shaped. The shape of the slot 205 can correspond to the shape of a cross-sectional surface of the blade support arm 201. For example, the slot 205 may be a rectangular slot and the blade support arm 201 may be a rectangular shaped member. The size of the slot 205 can be larger than a cross-sectional surface area of the blade support arm 201. In some implementations, the blade support arm 201 has a cylindrical form (e.g., cylinder). In other implementations, the blade support arm 201 has a rectangular form (e.g., rectangular prism). In still other implementations, the blade support arm 201 has a geometric form. In yet other implementations, the blade support arm 201 has an irregular form. In some implementations, the blade support arm 201 is formed of metal (e.g., stainless steel, titanium).

A material 203 can be introduced into the enclosure 101 via the tubing 107. The material 203 can be loaded into a syringe 108 and injected through the tubing 107. The material 203 can be directed into the interior volume of the enclosure 101 through the outlet of the tubing 107. The material 203 can include reactants, polymers, and/or additives. The enclosure 101 can be rotated by the rotator chuck assembly 102 to induce a stirring of the material 203 and generate an extensional flow within the material 203. Tubing 107, 109a, 109b may remain in position (i.e., at least partially extending within the enclosure 101) during rotation of the enclosure 101.

As the enclosure 101 rotates, the blade 202, fixedly held in place by the blade support arm 201, may flex (e.g., a flexible blade illustrated in FIGS. 2A-2C). The rotation of the enclosure 101 causes the material 203 to pass beneath blade 202 generating extensional flow and/or shear flow within the material 203. As rotation of the enclosure 101 continues, at least a portion of the material 203 can be wiped on the interior surface of the enclosure 101, forming a coating on the surface of the enclosure 101. The material coating the interior surface of the enclosure 101 can then be reintroduced into the pool of material 203 disposed in the gap 204 with subsequent rotation of the enclosure 101, thereby continuously exposing the material to periodic extensional flow. In this way, the flow-rotation process repeats periodically at a rate determined by the relative rotation between the blade 202 and the enclosure 101. Consequently, the material 203 can undergo continuous exposure to periodic extensional flow and/or shear flow. The flow-rotation process is distinct from other processes, such as spin coating, which can only apply a single extensional flow within a material.

The blade support arm 201 can extend within the enclosure 101 and can be angled within the enclosure 101. In some implementations, a surface of blade 202 contacts the interior surface of the enclosure 101. In other implementations, the blade 202 does not contact the interior surface of the enclosure 101. A gap 204 can be defined between a surface of the blade 202 and the interior surface of the enclosure 101. The gap 204 can be tunable by adjusting the position of the blade support arm 201 (e.g., via adjusting tip-tilt base plate 104 and/or the translation stage 112). FIGS. 2A-2C illustrate a gap 204 between a flexible blade 202 and the interior surface of an enclosure 101. In some implementations, the gap 204 is between 1 and 5 mm. In other implementations, the gap 204 is between 5 to 10 mm. In still other implementations, the gap 204 is 10 mm or larger. The size of the gap 204 between the blade 202 and the interior surface of the enclosure 101 can affect the extensional flow generated within a material when the enclosure 101 is rotated. The size of the gap 204 can be optimized to minimize excessive shear flow, extensional flow and/or prevent obstruction of the flow. The viscosity and flow characteristics of the material 203 as well as the stiffness and shape of the blade 202 may influence the size of the gap 204. The geometry of the blade 202 and/or geometry of the enclosure 101 may influence the size of the gap 204. The gap 204 can be defined in the region of the material that is between the blade 202 and the interior surface of the enclosure 101.

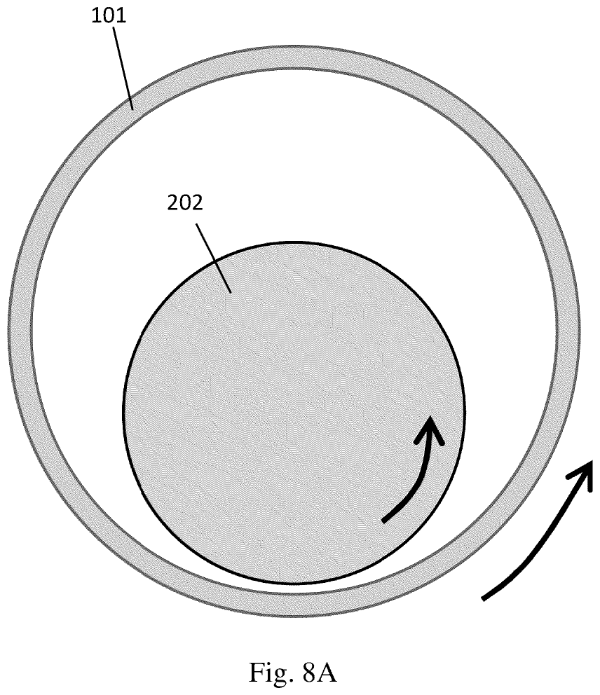

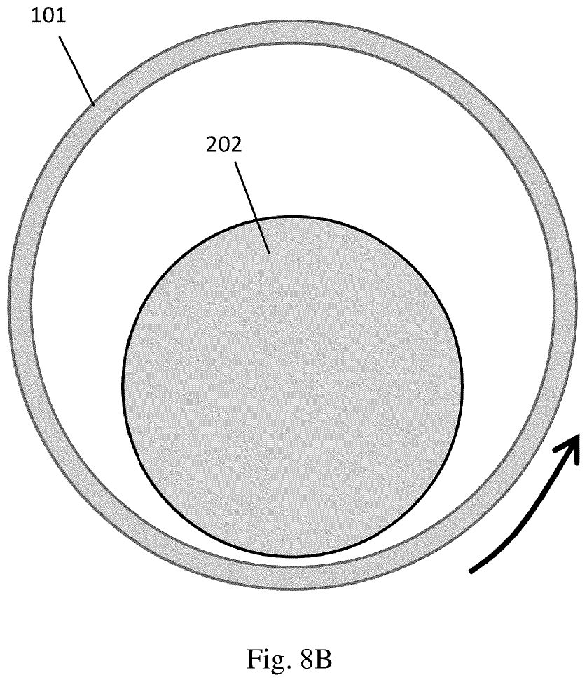

The blade 202 can be configured as a flap blade, a roller blade (e.g., cylindrical blade, cylindrical shell blade), or any other shaped blade. In its flap configuration, the blade 202 can be different shapes including circular, rectangular, polygonal, or irregularly shaped. Examples of the flap configuration of the blade 202 are illustrated in FIGS. 2A-4. The blade 202 may be a rigid blade or a flexible blade. In some implementations, the blade 202 is formed of Teflon. Alternatively, the blade 202 may be configured as a roller blade which can be various shapes such as cylindrical or other profiles suited for rotational movement. For example, FIGS. 8A and 8B show cross-sectional views of an implementation of a blade 202 in a roller configuration in which the blade is disposed within the enclosure 101. More specifically, FIG. 8A shows the blade 202 and the enclosure 101 rotating together, as indicated by the arrows. FIG. 8B shows the blade 202 stationary while the enclosure 101 rotates, with the rotation also depicted by arrows.

In implementations where the blade 202 does not contact the interior surface of the enclosure 101, the blade support arm 201 can be configured to rotate within the enclosure 101, while the enclosure 101 can either rotate or remain stationary.

In some implementations where the blade 202 contacts the interior surface of the enclosure 101, the enclosure 101 can rotate while the blade support arm 201 remains stationary (e.g., a fixed flap blade). In other implementations where the blade 202 contacts the interior surface of the enclosure 101, the enclosure 101 remains stationary and the blade support arm 201 is configured to rotate within the enclosure 101. As a result, the blade 202 can rotate together with the blade support arm 201. For example, the blade support arm 201 may be rotatably coupled to the first mounting plate 103. The blade support arm 201 may be rotated by an actuator (e.g., motor), which controls the rotation of the blade support arm 201.

In some implementations, where the blade 202 contacts the interior surface of the enclosure 101, the enclosure 101 and the blade support arm 201 can both rotate either at the same speed or at different speeds. In some implementations, the enclosure 101 and the blade support arm 201 rotate in the same direction. The variations in rotation speed and rotational direction may allow for different operational dynamics. In some implementations, the blade support arm 201 is rotatably coupled to the first mounting plate 103. In those implementations the blade support arm 201 rotates in response to the rotation of the enclosure 101, due to the contact between the blade 202 and the interior surface of the enclosure 101.

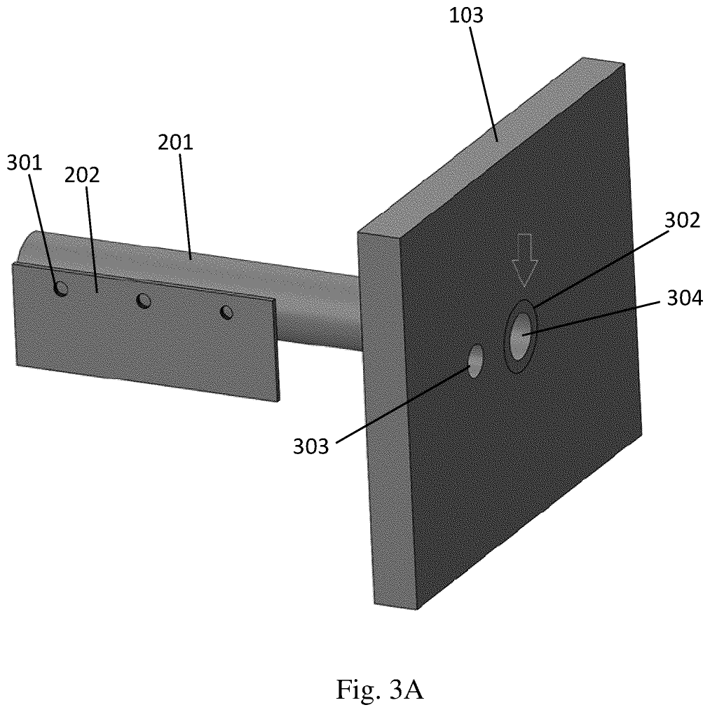

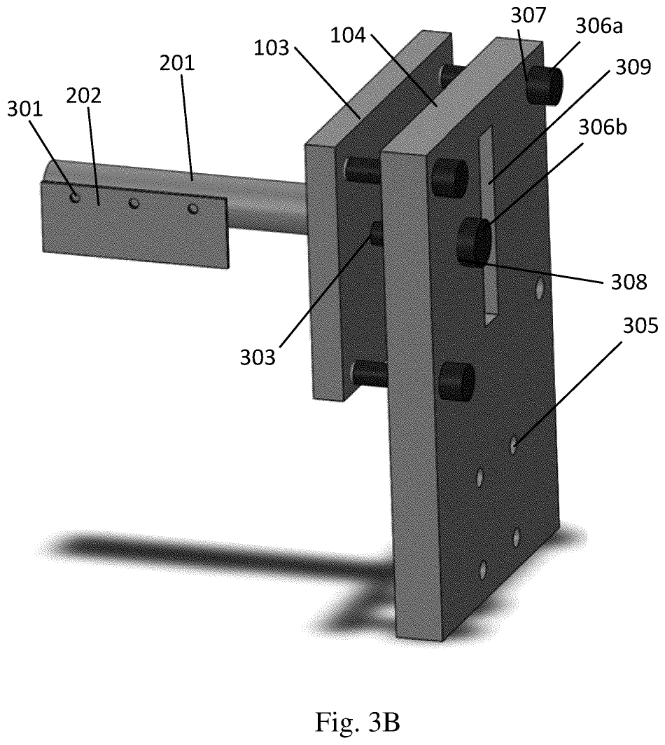

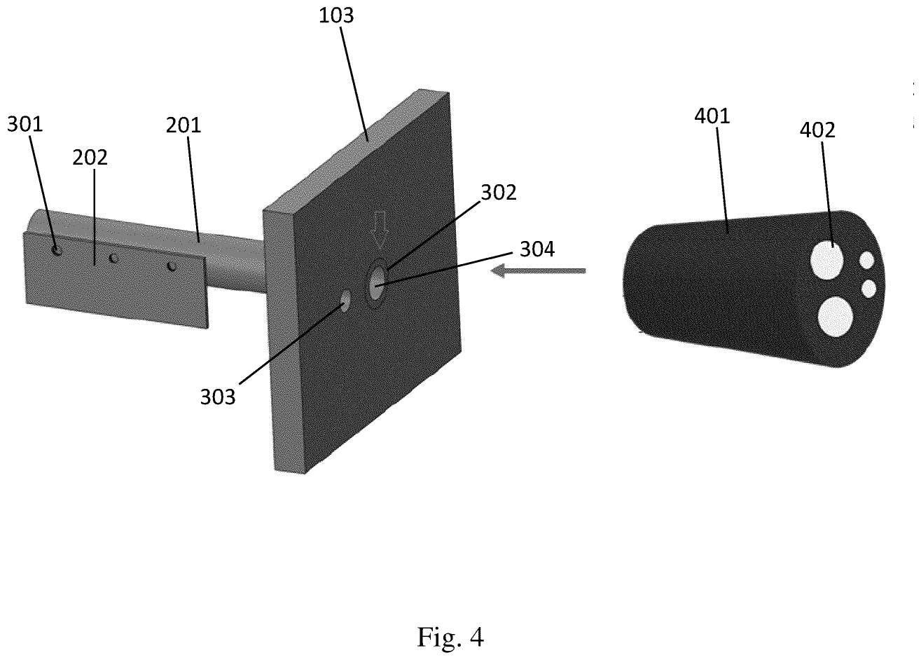

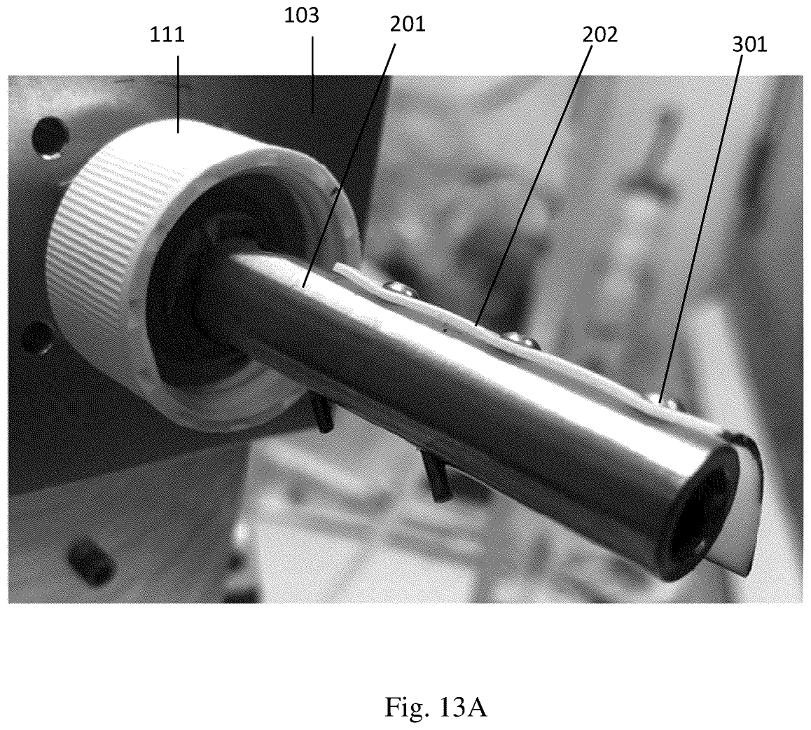

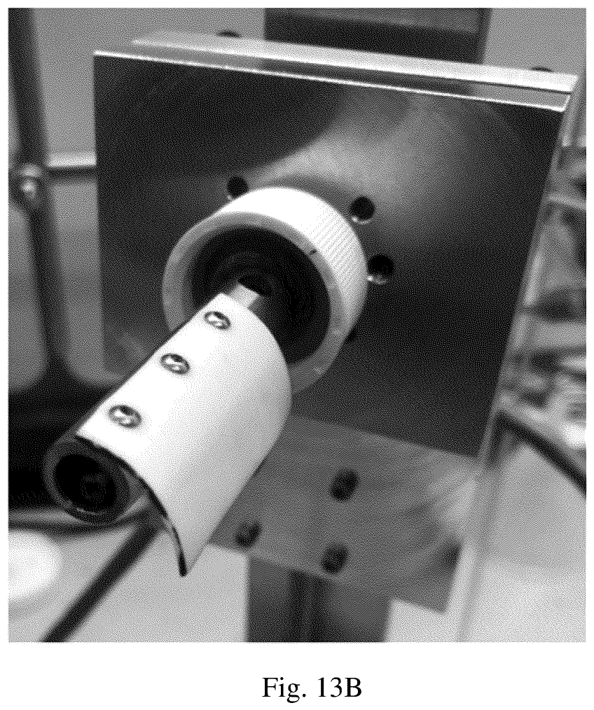

Referring now to FIGS. 3A-3B, and with additional reference to FIG. 4, various views of portions of a first implementation of a periodic extensional flow reactor are shown. The second end of the blade support arm 201 can be coupled with a blade 202, while the first end of the blade support arm 201 can be coupled to a first mounting plate 103. The blade support arm 201 can include an attachment point 301 for coupling a blade 202 to the blade support arm 201. In some implementations, the attachment point 301 is a plurality of attachment points. The attachment point can include a through-hole shaped and sized to receive a fastener which can be extend through openings on the blade 202 to form an attachment with the blade 202. The blade 202 can be coupled along the longitudinal length of the blade support arm 201, positioned towards the second end of the blade support arm 201. The blade support arm 201 can extend through the cap 111 (not shown in FIG. 3A), positioning the cap such that a surface of the cap 111 is either adjacent to or flush with a surface of the first mounting plate 103, as shown in FIGS. 13A-13B. A first opening 302 can extend through the thickness of the first mounting plate 103. The first opening 302 can be sized and shaped to receive the first end of the blade support arm 201, such that the exterior surface of the blade support arm 201 abuts the interior surface of the first opening 302. The first end of the blade support arm 201 can have external threads, while the first opening 302 of the first mounting plate 103 can include corresponding internal threads. This threading configuration allows the blade support arm 201 to be threadably coupled with the first mounting plate 103.

Still referring to FIGS. 3A-3B, and in greater detail, and with additional reference to FIG. 4, the first mounting plate 103 can include a second opening 303 that extends through the thickness of the first mounting plate 103. The pin 306b and the second opening 303 can each have corresponding threads. The tip-tilt base plate 104 can include an opening 308 that aligns with the opening 303 of the first mounting plate 103. The opening 308 of the tip-tilt base plate 104 can have corresponding internal threads to the external threads of the pin 306b. The second opening 303 of the first mounting plate 103 and the opening 308 of the tip-tilt base plate 104 can be sized and shaped to receive a pin 306b. In some implementations, the pin 306b is a fastener which can include a screw, bolt, nut, and/or washer. The pin 306b can extend through the tip-tilt base plate 104 and at least partially through the first mounting plate 103. In this way, the tip-tilt base plate 104 can be coupled (e.g., threadably coupled) to the first mounting plate 103.

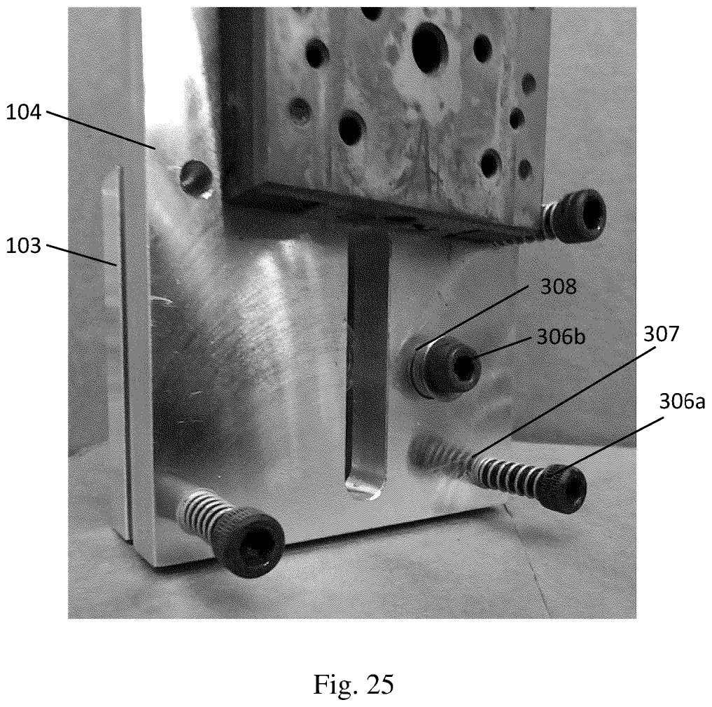

The tip-tilt base plate 104 can include a plurality of openings 307 that each extend through the thickness of the tip-tilt base plate 104. The plurality of openings 307 can each be sized and shaped to receive a pivot point 306a. The plurality of openings 307 can each included internal threads corresponding to external threads of a pivot point 306a. In some implementations, the pivot point 306a is a bolt with a spring as shown in FIG. 25. Each of the pivot points 306a can extend through a respective opening 307 and project beyond the opening such that a distal end of each pivot point 306a contacts with the first mounting plate 103. By adjusting one or more pivot points 306a, a pressure or force can be applied against different portions of the first mounting plate 103, which can cause the plate to tilt accordingly. This adjustment allows angling and positioning of the blade support arm 201 within the enclosure 101. Consequently, the gap 204 defined between the blade 202 and the interior surface of the enclosure 101 can be tunable.

The tip-tilt base plate 104 can include a slot 309, which may be an opening that extends through the thickness of the tip-tilt base plate 104. Tubing (e.g., 107, 109a, 109b) can be routed through the slot 309. The slot 309 of the tip-tilt base plate 104 can align with a first opening 304 of the blade support arm 201. The slot 309 may have various cross-sectional shapes, including circular, rectangular, triangular, or irregular shapes. The tip-tilt base plate 104 can include attachment points 305 which may be openings that at least partially extend through the thickness of the tip-tilt base plate. The openings can include internal threads corresponding to external threads of a fastener (e.g., screw, bolt). A translation stage 112 (shown in FIG. 1C) can be coupled to the tip-tilt base plate 104 via the attachment points 305. The translation stage 112 can include a device or system to move the tip-tilt base plate 104 (coupled with the first mounting plate 103) it is coupled to. The translation stage 112 can move the tip-tilt base plate 104 in one or more directions (e.g., linear paths along x-, y-, and/or z-axis). The translation stage 112 can include a stage base, a rail, a carriage, a drive mechanism, and/or a control system. The stage base of the translation stage 112 can be coupled to the second mounting plate 105 and the slot 106 can be aligned with the slot 309 of the tip-tilt base plate 104. The carriage (i.e., the portion of the translation stage 112 that moves along the rail mounted on the stage base) can be coupled to the tip-tilt base plate 104. The drive mechanism of the translation stage 112 can control the movement of the carriage along the rail either manually (e.g., using screws, knobs) or automated (e.g., using motors, actuators). An automated translation stage 112 can include a control system with electronics and software.

In some implementations, a first opening 304 extends at least partially through the thickness of the blade support arm 201 along its longitudinal length. The first opening 304 may have various cross-sectional shapes, including circular, rectangular, triangular, or irregular shapes. A stopper 401 can be inserted at least partially through the first opening 304 as illustrated in FIG. 4. The stopper 401 can include a first end, a second end, and a thickness therebetween. The stopper 401 can include a plurality of openings 402 extending through the thickness of the stopper 401. The diameter of the openings 402 can vary. Tubing (e.g., 107, 109a, 109b) can be routed through each of the openings 402 of the stopper 401 and through the blade support arm 201. The stopper 401 may be formed of materials including, but not limited to, rubber, silicone, plastic (e.g., polyethylene, polypropylene), foam (e.g., polyurethane, neoprene foam), and/or metal (e.g., aluminum, stainless steel). In other implementations, tubing (e.g., 107, 109a, 109b) can be directly routed through the first opening 304 of the blade support arm 201.

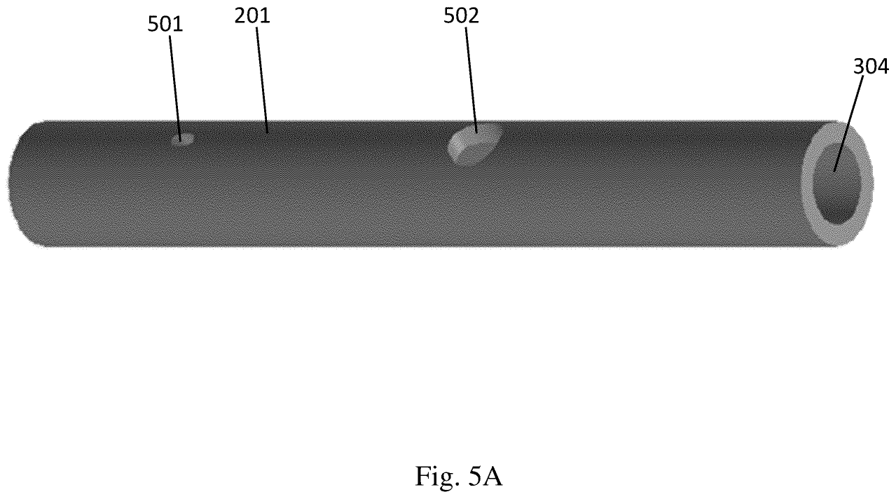

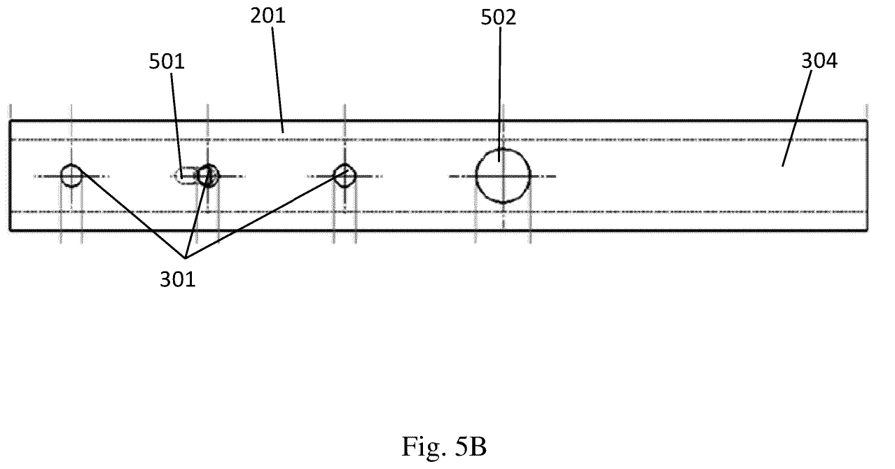

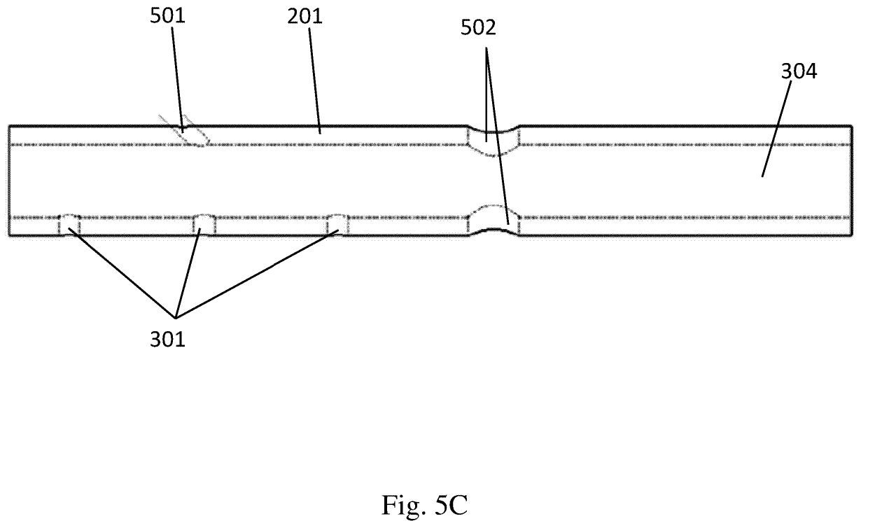

Referring now to FIGS. 5A-5C, and in brief overview, views of an implementation of a blade support arm 201 are shown. In some implementations, the blade support arm 201 can comprise a second opening 502 that extends through transversally through the blade support arm 201. In some implementations, the blade support arm 201 can include a third opening 501 that extends at least partially through the blade support arm 201 and is at an angle relative to a transversal axis (an axis perpendicular to the longitudinal axis of the blade support arm 201). The blade support arm 201 can include an attachment point 301 for coupling a blade 202 to the blade support arm 201. The attachment point 301 can include an opening that at least partially extends through the blade support arm 201. The opening can be sized and shaped to receive a fastener (e.g., screw, bolt, nut, and/or washer). In some implementations, the attachment point 301 includes a plurality of attachment points.

Tubing (e.g., 107, 109a, 109b) can extend through the slot 106 of the second mounting plate 105, the slot 309 of the tip-tilt base plate 104, and through the first opening 304 of the blade support arm 201. In some implementations, a first end of the tubing (e.g., 107, 109a, 109b) can extend through the third opening 501.

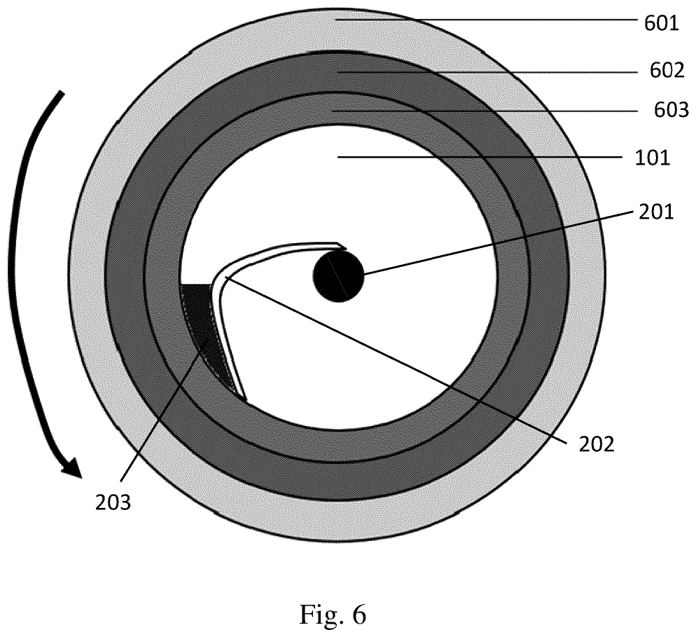

Referring now to FIG. 6, a cross-sectional view of an implementation of a heat transfer system for an enclosure 101 is shown that includes an insulator 601, a layer for heating and/or cooling 602, and a conductor 603. The conductor 603 can be disposed between the exterior surface of the enclosure 101 and the layer for heating and/or cooling 602. The layer for heating and/or cooling 602 can be disposed between the insulator 601 and the conductor 603. The conductor 603 can be sized and shaped to wrap around the exterior surface of the enclosure 101. The layer for heating and/or cooling 602 can be sized and shaped to wrap around a surface of the conductor 603 disposed opposite of the exterior surface of the enclosure 601. The insulator 601 can be sized and shaped to wrap around a surface of the layer for heating and/or cooling 602 disposed opposite of the conductor 603. In some implementations, the insulator 601, the layer for heating and/or cooling 602, and the conductor 603 have a cylindrical shell form. In some implementations, the insulator 601 is formed of a ceramic fiber. In some implementations, the layer for heating and/or cooling 602 is formed of a heat-resistant, temperature-controllable material. In some implementations, the layer for heating and/or cooling 602 includes a flexible heating element. In some implementations, the layer for heating and/or cooling 602 includes a flexible cooling element. In some implementations, the layer for heating and/or cooling 602 includes an electrically conductive polymer. In some implementations, the layer for heating and/or cooling 602 includes temperature sensors for monitoring and/or regulating the heat output. In some implementations, the conductor 603 is formed of a material with a high thermal conductivity (e.g., aluminum, copper). In some implementations, the heating layer can be substituted by a cooling layer. In some implementations, the heating layer can be substituted by a layer that can both heat and cool.

In some implementations, the periodic extensional flow reactor system can include a cooling system (e.g., air cooling, ventilation, heat sink, liquid cooling). The cooling system can include an insulator, a cooling layer, and a conductor layer. In some implementations, the periodic extensional flow reactor system can include a pressure control system which can include pressure regulators. In some implementations, the periodic extensional flow reactor system includes a monitoring and control system which can include a data acquisition system. In some implementations, the periodic extensional flow reactor system includes a temperature control system which can control the temperature within the enclosure 101. In some implementations, portions (e.g., blade support arm 201, blade 202) of the periodic extensional flow reactor are corrosion resistant.

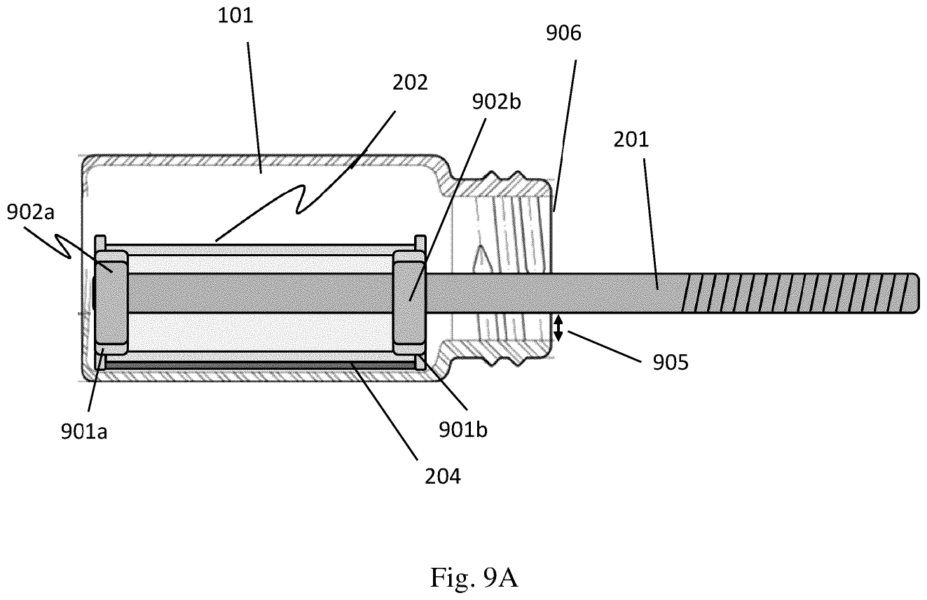

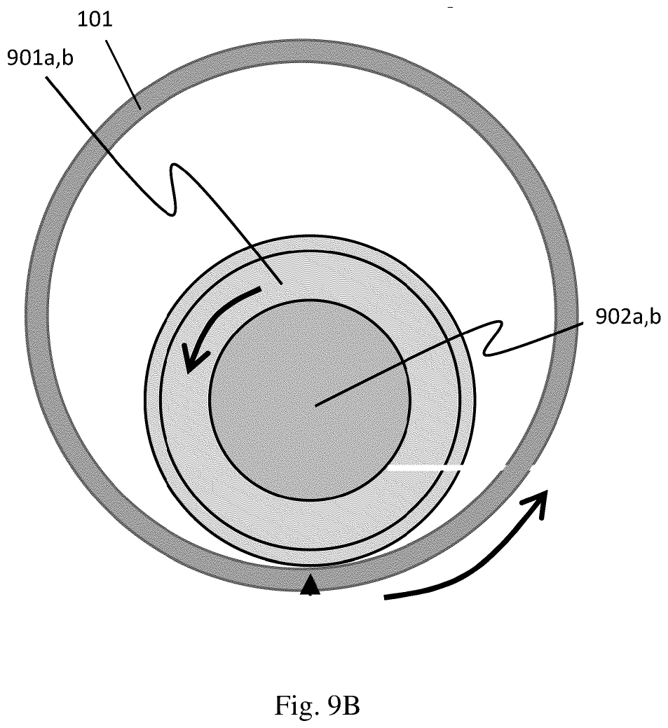

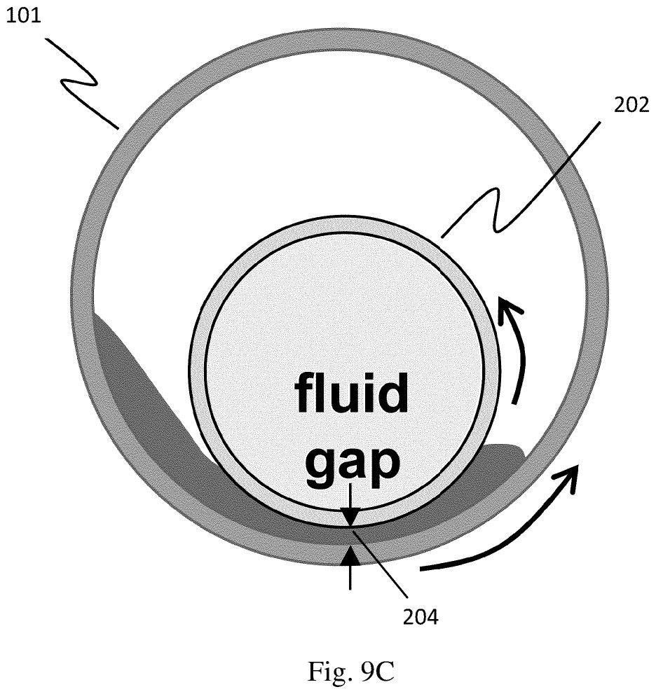

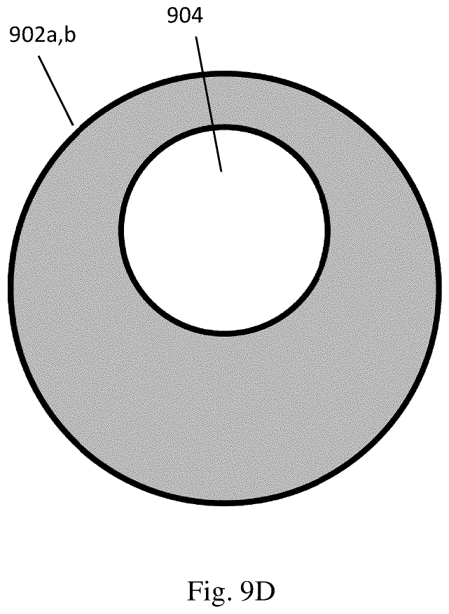

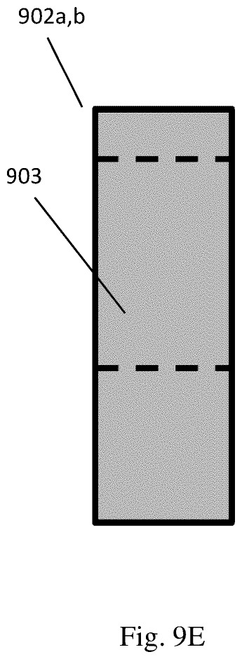

Referring now to FIGS. 9A-9E, and in brief overview, side views and cross-sectional views of an implementation of a portion of a periodic extensional flow reactor system are shown including an enclosure 101, a blade support arm 201, and a blade 202 having a roller configuration. The enclosure 101 can include an opening 906 disposed at one end of the enclosure 101, an exterior surface, and an interior surface defining an interior volume. The opening 906 can extend through to the interior volume of the enclosure 101. In some implementations, the interior volume has a capacity of 20 mL. The interior surface and/or exterior surface can be a curved surface (e.g., cylindrical, circular cross-section). The enclosure 101 can include a body having at least two diameters. The enclosure 101 can include a large diameter portion and a smaller diameter portion, which together form a tapered or stepped profile. The smaller diameter portion of the enclosure 101 can include a threaded portion having external threads. The threaded portion can couple with a threaded portion of a cap, such as cap 111. The blade support arm 201 can include bearings 901a,b and bearing plugs 902a,b.

Still referring to FIGS. 9A-9E, and in greater detail, a blade support arm 201 may extend into the interior volume of the enclosure 101. The blade support arm 201 can be a rigid member having a first end, a second end, and a thickness therebetween. A first end of the blade support arm 201 may be secured in place (e.g., rigidly coupled) between a cap (e.g., cap 111) and a first mounting plate (e.g., mounting plate 103). The first end of the blade support arm 201 can be coupled to the first mounting plate. The blade support arm 201 can extend through the cap, positioning the cap such that a surface of the cap is either adjacent to or flush with a surface of the first mounting plate. In some implementations, the blade support arm 201 is formed of stainless steel. In other implementations, the blade support arm 201 is formed of aluminum. The blade support arm 201 can be formed of a material with a high stiffness which can reduce deflection during loading. In some implementations, the blade support arm 201 includes a socket head screw. In those implementations, the head of the socket head screw may be removed which can provide a smooth shaft for press-fitting into the blade 202. In some implementations, a portion of the first end of the blade support arm 201 includes external threads which can correspond to the internal threads of the first mounting plate.

A tip-tilt base plate (e.g., tip-tilt base plate 104) can be coupled (e.g., threadably coupled) to the first mounting plate. The tip-tilt base plate can include a plurality of openings (e.g., openings 307) that each extend through the thickness of the tip-tilt base plate. The plurality of openings can each be sized and shaped to receive a pivot point (e.g., pivot point 306a). Each of the pivot points can extend through a respective opening of the tip-tilt base plate and project beyond the opening such that a distal end of each pivot point makes contact with the first mounting plate. By adjusting one or more pivot points, a pressure or force can be applied against different portions of the first mounting plate, which can cause the plate to tilt accordingly. This adjustment allows angling and positioning of the blade support arm 201 within the enclosure 101. Consequently, the gap 204 defined between the blade 202 and the interior surface of the enclosure 101 can be tunable.

A translation stage (e.g., translation stage 112) can be coupled to the tip-tilt base plate via attachment points on the tip-tilt base plate (e.g., attachment points 305). The translation stage can include a device or system to move the tip-tilt base plate (coupled with the first mounting plate) is it coupled to. The translation stage can move the tip-tilt base plate in one or more directions (e.g., linear paths along x-, y-, and/or z-axis). The stage base of the translation stage can be coupled to a second mounting plate (e.g., second mounting plate 105). The carriage (i.e., the portion of the translation stage that moves along the rail mounted on the stage base) is coupled to the tip-tilt base plate.

The blade 202 may be a cylindrical roller blade having an opening extending along the longitudinal axis. The blade 202 can be rotatably coupled to the blade support arm 201 via bearings 901a,b. The blade support arm 201 can extend through the opening 906 and the interior volume of the enclosure 101. The second end of the blade support arm 201 can be aligned with a second end of the blade 202. The second end of the blade support arm 201 and the second end of the blade 202 can be coupled with a bearing 901a and a bearing plug 902a. The first end of the blade 202 can be coupled to a portion of the blade support arm 201 (e.g., between the first end and second of the blade support arm 201) with a bearing 901b and bearing plug 902b.

In some implementations, the bearing 901a,b is a flanged bearing. In some implementations, the bearing 901a,b is an ultrathin roller bearing. In some implementations, the bearing 901a,b includes a rotating bearing collar. In some implementations, the bearing 901a,b is formed of stainless steel. In some implementations, the bearing 901a,b includes a flange. The width of the flange may extend past the outer diameter of the blade 202. In this way, the width of the flange determines the height of the gap 204 (the distance between the exterior surface of the blade 202 and the interior surface of the enclosure 101). In some implementations, the flange surface is roughened and/or rubberized. This roughening or rubberizing of the flange surface may improve the grip against the interior surface of the enclosure 101. In some implementations, the bearings 901a,b each include tape wrapped around the exterior surface of the bearing. In some implementations, the bearing 901a,b includes a press-fit metal ring. Additional materials (e.g., tape, press-fit metal ring) can be added to each of the bearings 901a,b to increase the gap 204. The blade support arm 201 can extend within the enclosure 101 and can be angled within the enclosure 101 so that a rotating portion (e.g., rotating bearing collar) of the bearings 901a,b contacts the interior surface of the enclosure 101. The rotating portion of the bearings 901a,b can include a flange.

In some implementations, the bearing plug 902a,b includes a body with an opening 903 extending through the thickness of the body. The opening 903 of the bearing plug 902a,b can be parallel to, but offset from, the longitudinal axis of the bearing plug 902a,b. For example, this offset of the opening 903 is illustrated in FIG. 9E. The bearing plug 902a,b can be different shapes including cylindrical, polygonal, rectangular, or irregularly shaped. The bearing plug 902a,b can be sized and shaped to fit at least partially through the first end and second end of the blade 202. In some implementations, the bearing plug 902a,b is formed of stainless steel. The bearing plug 902a,b may be press fit into the internal diameter of bearing 901a,b. The blade support arm 201 arm can extend at least partially through the opening 903 of each of the bearing plugs 902a,b. In this way, the blade support arm 201 is positioned offset from the longitudinal axis of the blade 202. This can provide a clearance 905 between the blade support arm 201 and the interior surface of the enclosure 101. The blade support arm 201 can be press-fit into the bearing plugs 902a,b.

In some implementations, the enclosure 101 and the blade support arm 201 both rotate. For example, the blade support arm 201 may be rotatably coupled to the first mounting plate (e.g., first mounting plate 103). The blade support arm 201 may be rotated by an actuator. In another example, the blade support arm 201 may be fixedly coupled to the first mounting plate (e.g., first mounting plate 103). In this way, a rotation of the enclosure 101 rotates the rotating portion of the bearings 901a,b, which consequently rotates the blade 202.

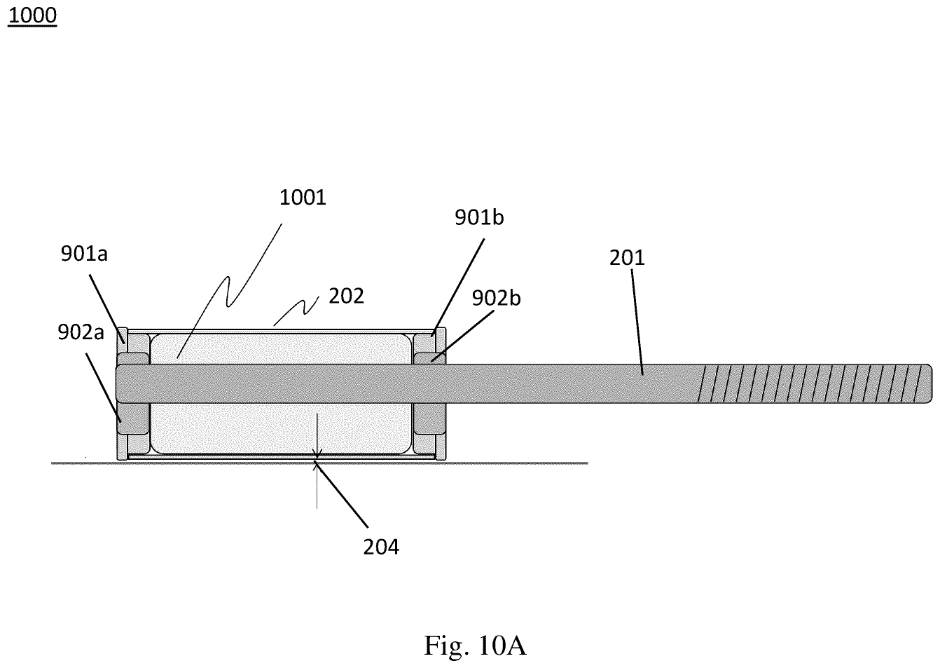

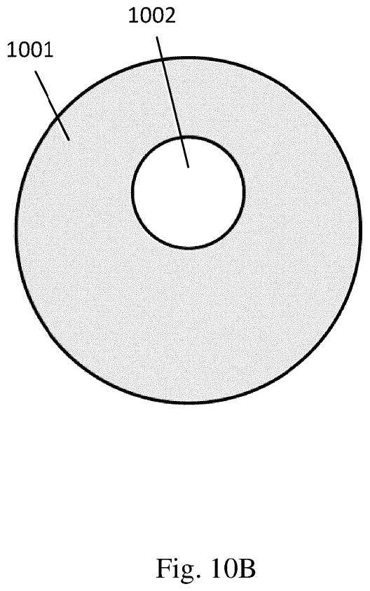

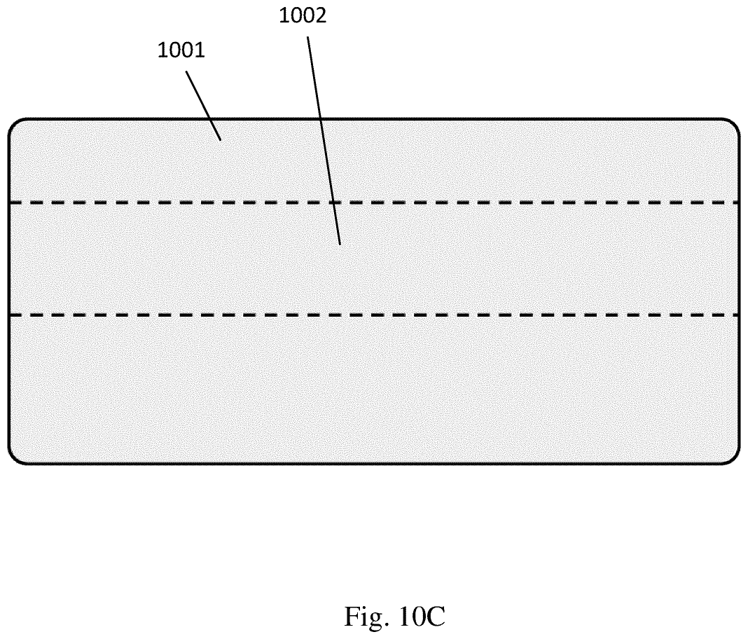

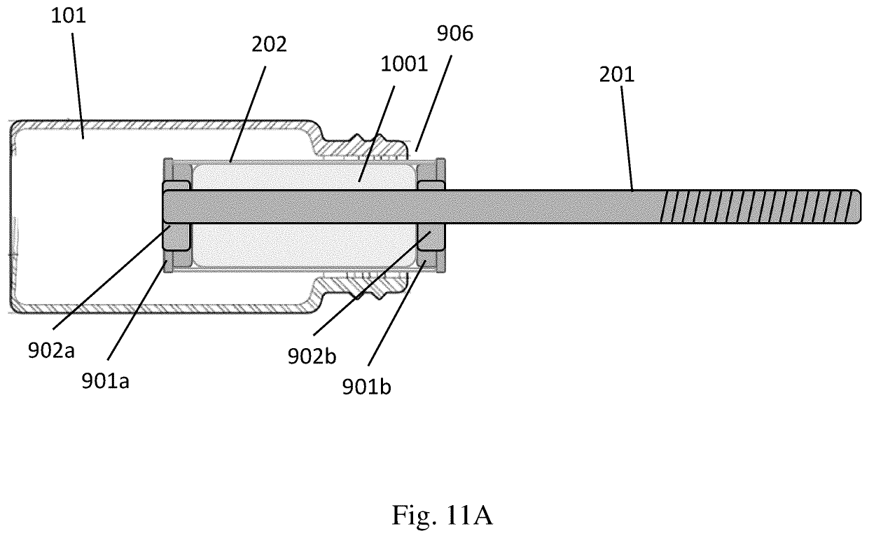

Referring now to FIG. 10A, with additional reference to FIGS. 10B-C, the blade 202, in a roller blade configuration, may include an internal support 1001. The internal support 1001 may prevent deformation of the blade 202. The internal support 1001 can include a body having an opening 1002 extending through the thickness of the body. The longitudinal axis of the opening 1002 can be parallel to, but offset from, the longitudinal axis of the body and the opening can align with the opening 903 of each of the bearing plugs 902a,b. The internal support 1001 can be different shapes including cylindrical, polygonal, rectangular, or irregularly shaped. The internal support 1001 can be sized and shaped to fit through the interior volume of the blade 202.

Still referring to FIG. 10A, with additional reference to FIGS. 10B-C, the blade support arm 201 can extend through the opening 1002 of the internal support 1001. In some implementations, the internal support 1001 is formed of polytetrafluoroethylene which may provide a looser fit with the blade support arm 201. In other implementations, the internal support 1001 is formed of resin and fiberglass (e.g., Garolite) which may provide a tighter fit with the blade support arm 201.

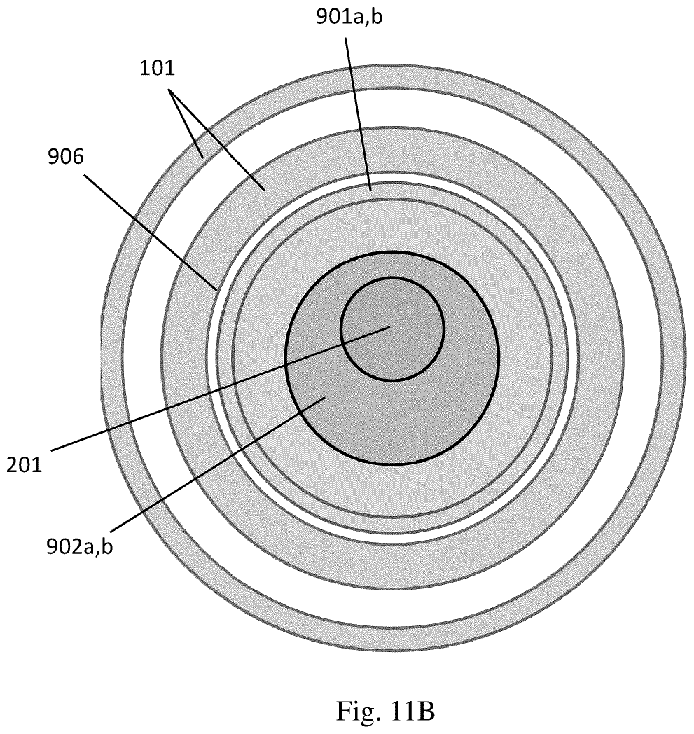

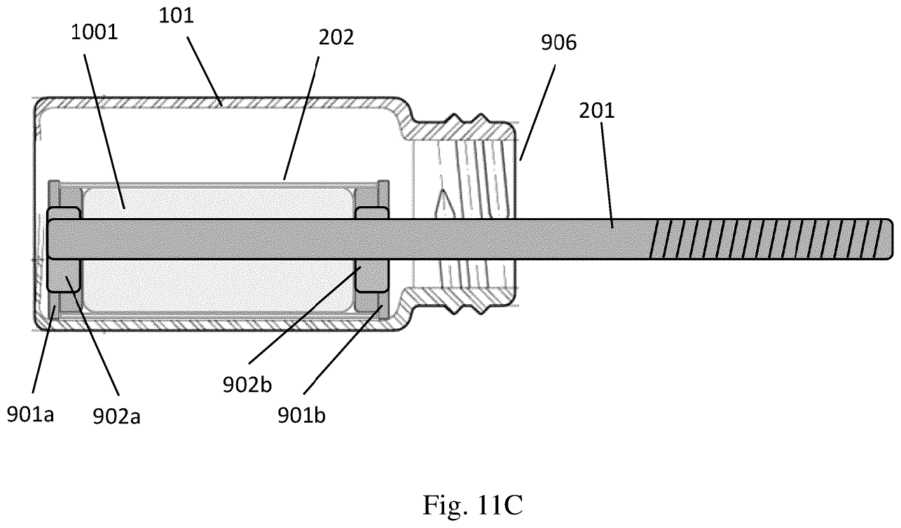

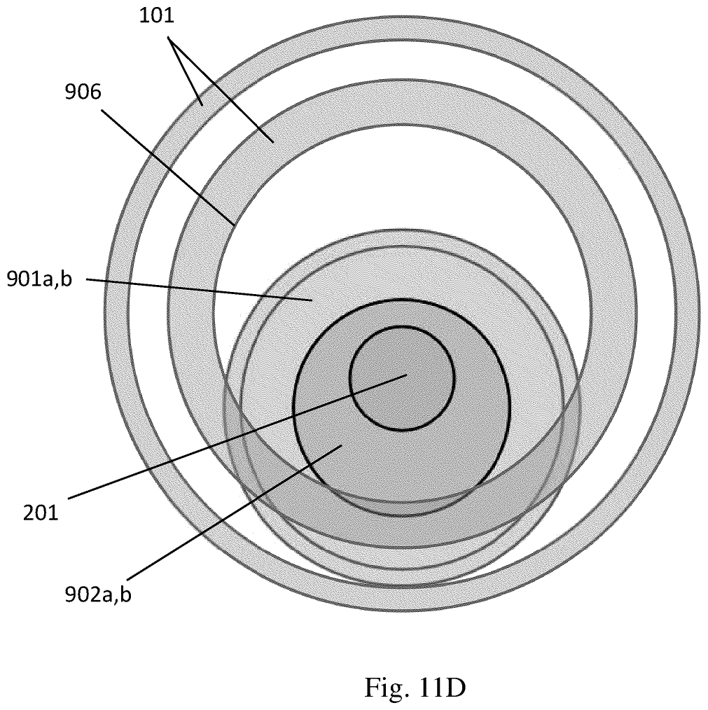

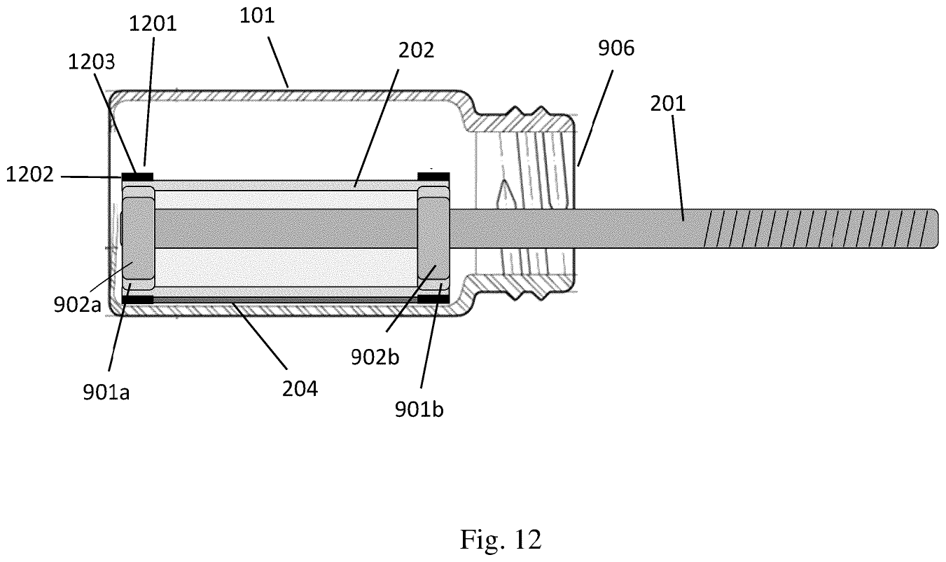

Referring now to FIGS. 11A-11D, side views and cross-sectional views of an insertion and alignment of the portion 1000 of the periodic extensional flow reactor shown in FIG. 10A is shown. FIG. 11A shows a side view of the portion 1000 inserted through an opening 906 of the enclosure 101. The corresponding cross-sectional view, FIG. 11B, shows the blade 202 concentrically positioned within the opening 906 of the enclosure 101. FIG. 11C shows a side of the portion 1000 aligned within the enclosure 101 such that a rotating portion of the bearings 901a,b contacts the interior surface of the enclosure 101. The corresponding cross-sectional view, FIG. 11D, shows the blade 202 non-concentrically positioned within the opening 906 of the enclosure 101.

In some implementations, the bearings 901a,b do not include a flange. In those implementations, a band 1201 can be disposed around each of the ends of the blade 202. The band 1201 can be cylindrical and can conform to the exterior surface of the enclosure 101. The band 1201 can vary in width 1203 and thickness 1202. The thickness 1202 of the band 1201 can determine the height of the gap 204. For example, a thicker band can be used to increase the height of the gap 204. The outer surface of the band 1201, disposed opposite of the exterior surface of the enclosure 101, can contact the interior surface of the enclosure 101. The band 1201 can be formed of a flexible material or a rigid material. In some implementations, the band 1201 can include a chemically resistant tape (e.g., Kapton tape). In some implementations, the band 1201 can be formed of Viton fluoroelastomer. In some implementation, the band is formed of a material (e.g., rubber) that can provide enhanced traction against the interior surface of the enclosure 101.

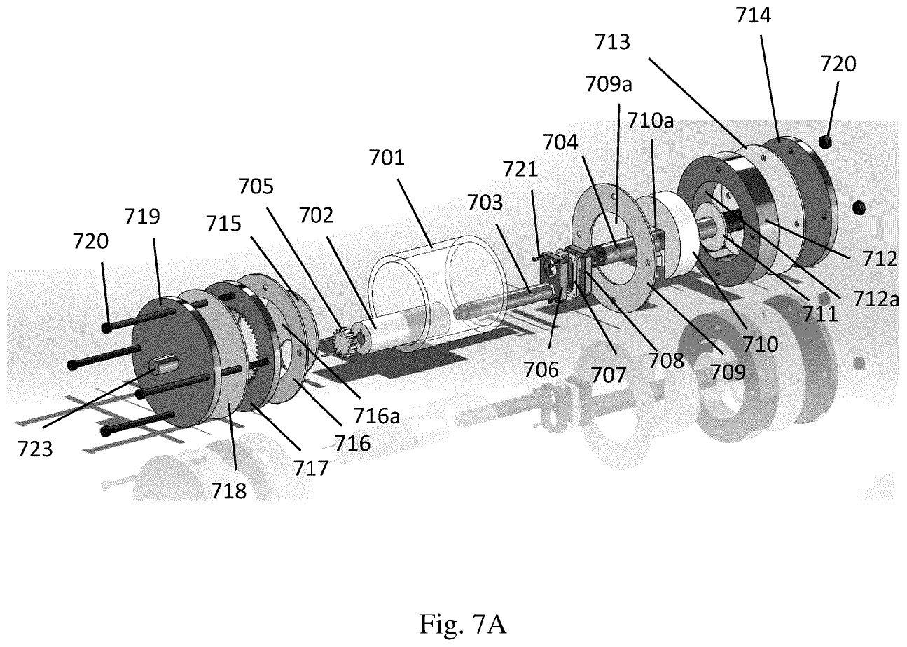

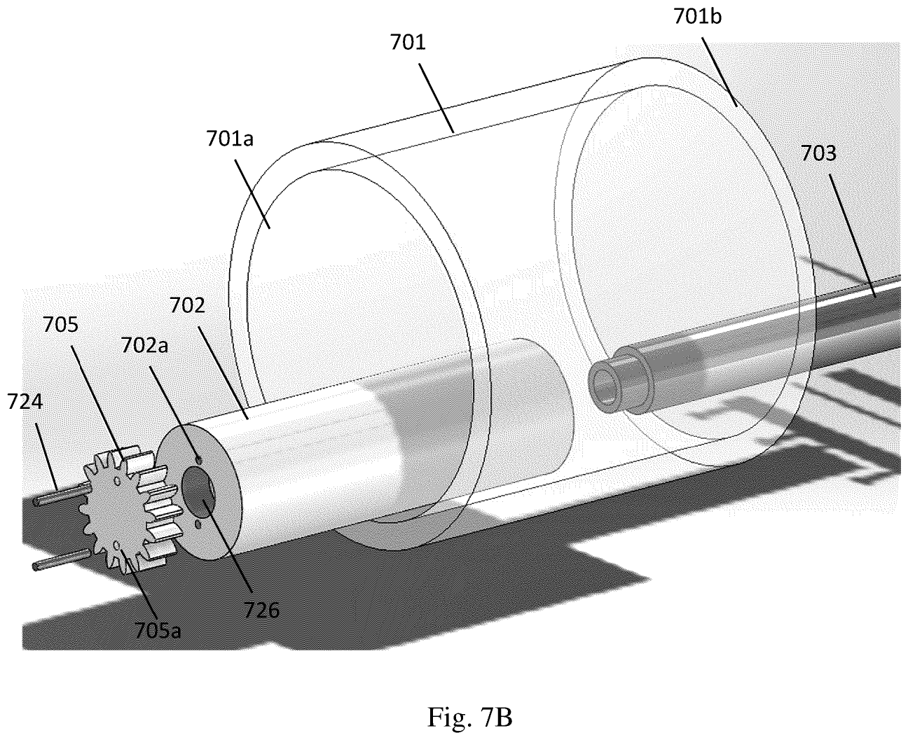

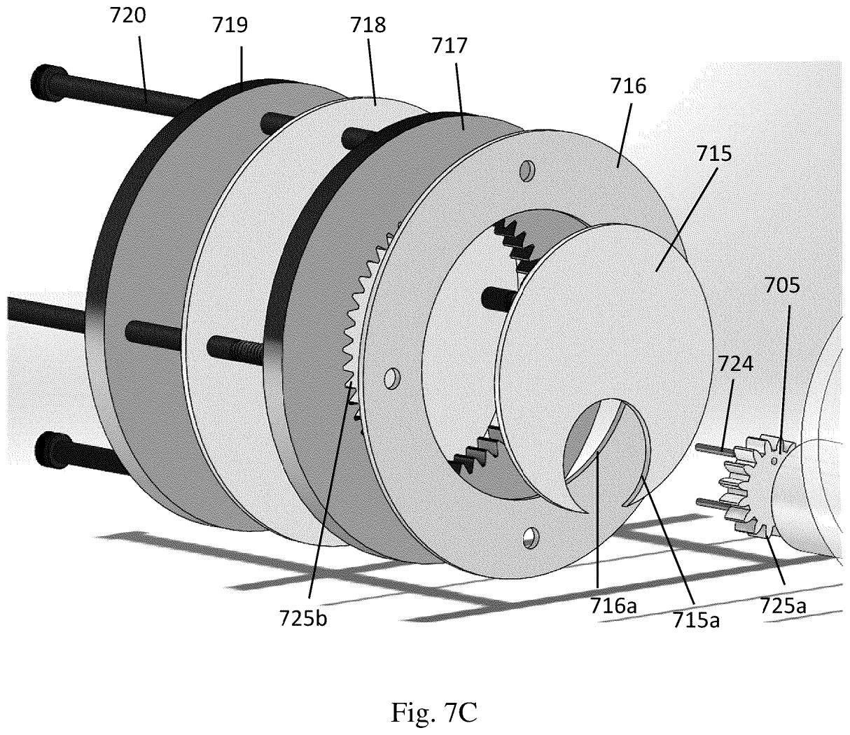

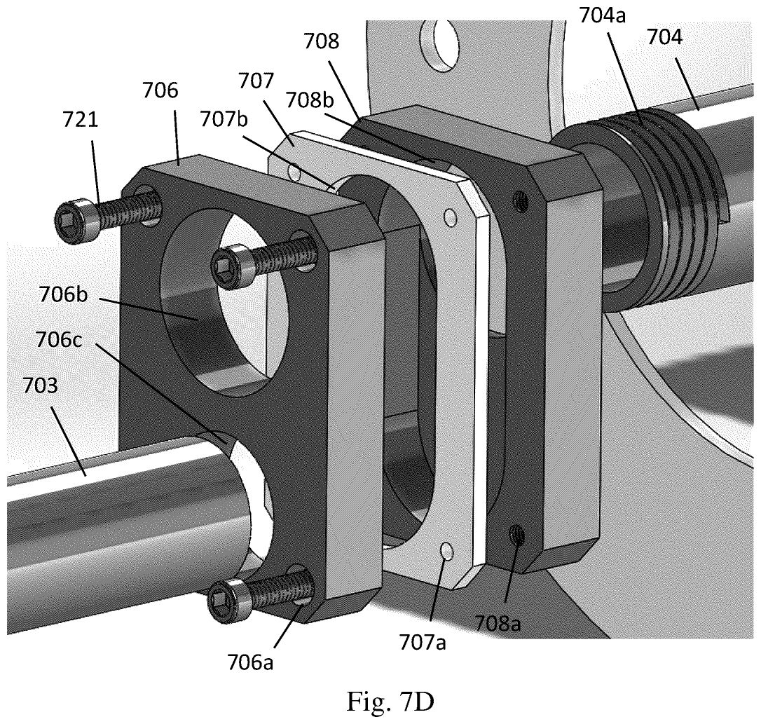

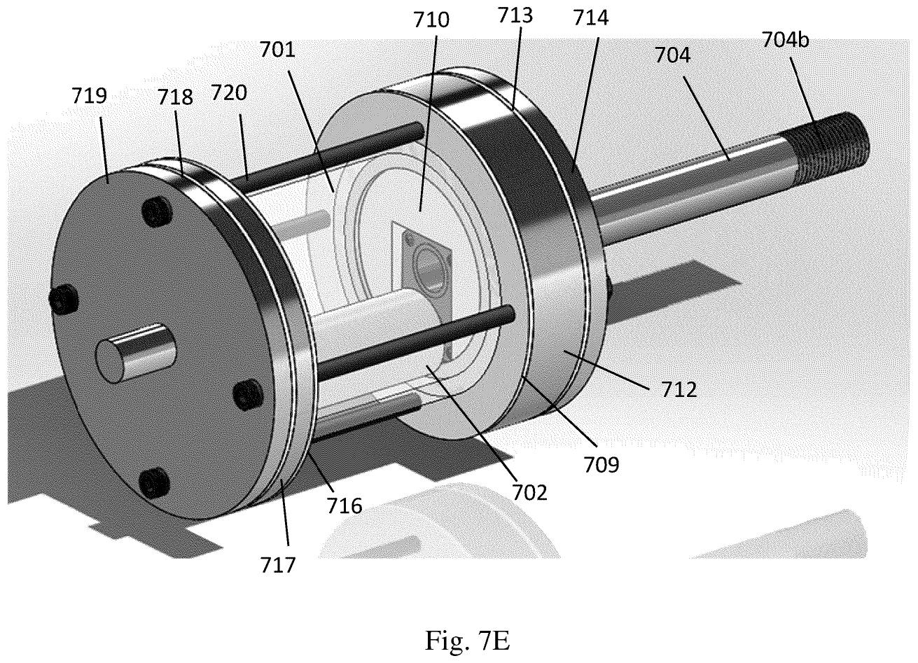

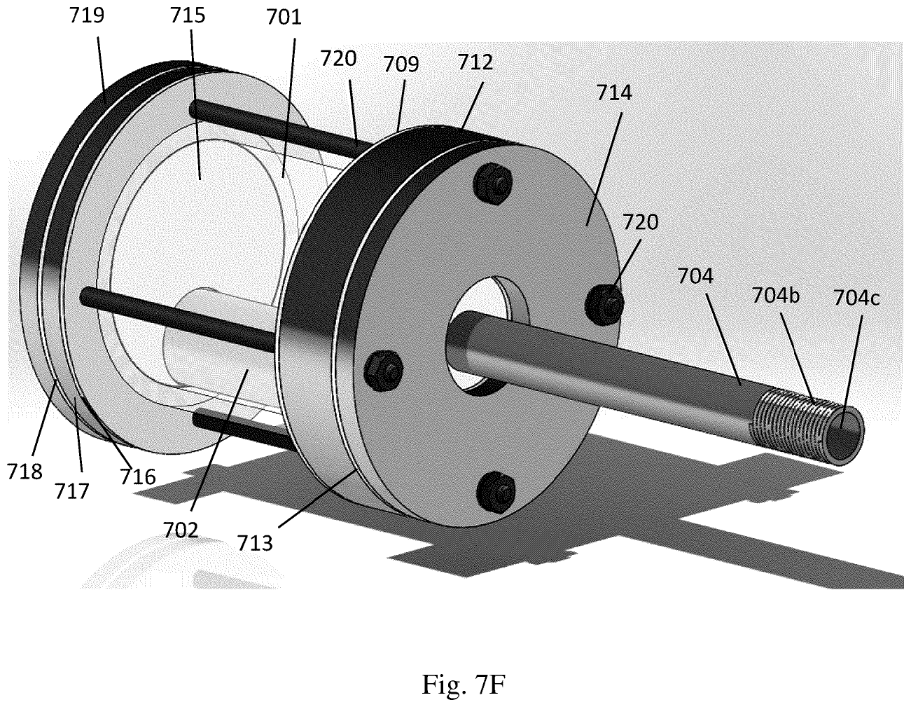

Referring now to FIG. 7A, and in brief overview, and with additional reference to FIGS. 7B-F, views of a second implementation of a periodic extensional flow reactor are shown, which include an enclosure 701, a blade 702, a blade shaft 703, and a blade support arm 704. It should be understood that portions of the first implementation described such as FIGS. 1A-6, may be incorporated in the second implementation of a periodic extensional flow reactor. A flow obstacle can include the blade support arm 704, the blade shaft 703, and the blade 702. The enclosure 701 may be substantially cylindrical in shape (e.g., cylindrical shell). The enclosure 701 can include two openings 701a,b disposed at each end of the enclosure 701, an exterior surface, and an interior surface defining an interior volume. The openings 701a,b can extend through to the interior volume of the enclosure 701. The blade shaft 703 can be coupled to the blade support arm 704, for example, by using a blade bracket 706 and/or an arm bracket 708. The blade 702 can extend through the enclosure 701. The blade 702 can be a cylindrical roller blade. The blade 702 can have a smaller outer diameter than the inner diameter of the enclosure 701. The blade 702 can have a first end, a second end, and a thickness therebetween in which an opening 726 extends through the thickness of the blade 702 and along the longitudinal axis of the blade 702.

The blade 702 can be angled and positioned within the enclosure 701. In some implementations, a surface of the blade 702 contacts the interior surface of the enclosure 701. In those implementations, the blade 702 may have a channel. For example, the channel of the blade 702 can be defined by a radial recess along a central portion of the body of the cylindrical roller blade, resulting in a reduced diameter in the central portion of the body compared to the diameters of the first and second ends of the body. The radial recess can be formed through a lathe process. The first and second ends of the blade 702 can contact the interior surface of the enclosure 701. The blade 702 can be configured so that it rotates with a rotation of the enclosure 701. A gap can be defined between the channel (e.g., the radial recess of the blade 702) and the interior surface of the enclosure 701. Extensional flow and/or shear flow can be generated in a material (e.g., 2 dimensional polymers) disposed in the gap. In this way, the channel geometry determines the gap thickness, and the alignment between the blade 702 and the enclosure 701 is maintained by the contact of the blade 702 ends with the enclosure 701. In some implementations, the blade 702 does not contact the interior surface of the enclosure 701 and the gap is defined by the distance between the blade 702 and the interior surface of the enclosure 701. The gap may be set by the positioning of the blade support arm 704, which can be adjusted via the tip-tilt base plate 104 and/or the translation stage 112. The gap may be set by the position of the opening 706c of the blade bracket 706, geometry of the gear 705 coupled with the blade 702, and geometry of the gear ring 717 that engages with gear 705.

In some implementations, the rotation of the blade 702 can be enabled by the engagement of the gear 705 with the gear ring 717 which is driven by the rotation of the enclosure 101. In other implementations, the rotation of the blade 702 can be enabled through traction between the first and second ends of the blade 702 with the interior surface of the enclosure 101.

In some implementations, the blade 702 can rotate around a stationary blade shaft 703. The opening 726 of the blade 702 can have a diameter that is larger than the diameter of the blade shaft 703 and the blade shaft 703 can be disposed through the opening 726 of the blade 702. In those implementations, the blade shaft 703 can be rigidly coupled to the blade support arm 704. For example, the blade shaft 703 can be fixedly coupled to the blade bracket 706.

In other implementations, the blade shaft 703 can be configured to rotate while being supported by the blade bracket 706, causing the blade 702 to rotate in unison with it. The opening 726 of the blade 702 can have a diameter such that the surface of the opening 726 abuts the exterior surface of the blade shaft 703. In this way, the blade 702 can be rigidly coupled to the blade shaft 703. In those implementations, the blade shaft 703 can be rotatably coupled to the blade support arm 704.

Still referring to FIG. 7A, and with additional reference to FIGS. 7B-7F, the blade shaft 703 can be coupled to the blade support arm 704 via a blade bracket 706 and/or an arm bracket 708. A bracket spacer 707 can be disposed between the blade bracket 706 and arm bracket 708. The bracket spacer 707 can serve several purposes including, but not limited to, separation and clearance between the brackets 706, 708, alignment between the brackets 706,708, load distribution, vibration dampening, and/or prevent damage due to thermal expansion. The blade bracket 706, bracket spacer 707, and arm bracket 708 can be coupled to each other using fasteners 721 (e.g., bolt, screw, nut, washer). The blade bracket 706, bracket spacer 707, and arm bracket 708 can each include a plurality of fastener openings, 706a, 707a, and 708a, respectively, that extend through a thickness of their respective brackets. In some implementations, the bracket spacer 707 can be formed of nylon, polyethylene, polycarbonate, fiberglass, carbon fiber, neoprene, silicone, stainless steel, aluminum, and/or brass. The blade bracket 706, bracket spacer 707, and arm bracket 708 enable the insertion of a cartridge heater with thermocouple (not shown) to be inserted through the blade shaft 703. The wires from the cartridge heater with thermocouple can pass through the respective openings of the bracket 706, bracket spacer 707, arm bracket 708, and through the blade support arm 704 to the exterior of the system where the wires can connect with a controller (e.g., temperature controller, heating system, and/or cooling system).

A portion of the blade shaft 703 can extend at least partially through an opening 706c of the blade bracket 706. The second end 704a of the blade support arm 704 can extend through the opening 708b of the arm bracket 708, the opening 707b of the bracket spacer 707, and the opening 706b of the blade bracket 706. The second end 704a can be coupled (e.g., rigidly coupled, threadably coupled) to the opening 706b of the blade bracket 706. The second end 704a of the blade support arm 704 can include a threaded portion having external threads and the surface of the opening 706b can include corresponding internal threads.

The blade 202 can include a gear 705 having gear teeth 725a. The gear 705 and the blade 202 can be rigidly coupled to each other. The blade 202 and gear 705 can each include openings, 702a and 705a, respectively. The openings 702a and 705a can align such that a pin 724 (e.g., rivet, dowel pin, screw, bolt) can extend through both openings 702a and 705a. The opening 702a can at least partially extend through the thickness of the blade 702 and along the longitudinal axis of the blade 702. The opening 705a can at least partially extend through the thickness of the gear 705 and along the longitudinal axis of the gear 705.

Still referring to FIG. 7A, and with additional reference to FIGS. 7B-7F, the ends of the enclosure 701 can be sealed with a first enclosure plate 709 and a second enclosure plate 716. The first enclosure plate 709 and the second enclosure plate 716 can each include openings, 709a and 716a, respectively, that extend through the thickness of each of the respective plates. The openings 709a and 716a can have a diameter smaller than the openings 701a,b of the enclosure 701. A support plate 712 can be disposed between a first end plate 714 and the first enclosure plate 709. The support plate 712 can include a first end, a second end, a thickness therebetween, and an opening 712a extending through the thickness. A bracket support block 710 can be disposed within the opening 712a of the support plate 712. The bracket support block 710 can include a first end, a second end, a thickness therebetween, and an opening 710a extending through the thickness. The bracket support block 710 can be sized and shaped to fit within the opening 712a of the support plate 712. The bracket support block 710 can be different shapes such as cylindrical, polygonal, rectangular, or irregularly shaped. The opening 710a of the bracket support block 710 can be a rectangular opening that is offset from the longitudinal axis of the bracket support block 710. The opening 710a can extend through an edge of the bracket support block 710. A spacer plate 713 can be disposed between the support plate 712 and the first end plate 714.

A gear end plate 715 can be disposed within the opening 716a of the second enclosure plate 716. A gear ring 717 can be disposed between a second end plate 719 and the second enclosure plate 716. A spacer plate 718 can be disposed between the gear ring 717 and the second end plate 719. In some implementations, the spacer plate 713,718 can be formed of nylon, polyethylene, polycarbonate, fiberglass, carbon fiber, neoprene, silicone, stainless steel, aluminum, and/or brass. An arm plate 711 can be disposed between the bracket support block 710 and the spacer plate 713 and/or the first end plate 714.

The second end plate 719, spacer plate 718, gear ring 717, second enclosure plate 716 can each include openings that align such that a fastener 720 can extend through each of the openings. Similarly, the first end plate 714, spacer plate 713, support plate 712, and first enclosure plate 709 can each include openings that align such that an end of the fastener 720 extends through each of the openings. In this way, the end plates 714,719, spacer plates 713,718, gear ring 717, enclosure plates 709,716, support plate 712, and the enclosure 701 are coupled to each other. The fastener 720 can include a threaded bolt or screw and a nut, in which the nut is used to secure the fastener.

In some implementations, the second end plate 719 includes a shaft 723 rigidly coupled to the second end plate 719. In those implementations, a rotator chuck assembly (e.g., rotator chuck assembly 102) can be coupled to the shaft 723. The rotator chuck assembly can be configured to hold and rotate the enclosure 701. It should be understood that the rotator chuck assembly can be coupled to the second plate 719 and/or the enclosure 701 in various ways. For example, the rotator chuck assembly can be coupled directly to the second plate 719. In another example, the rotator chuck assembly can be coupled directly to the exterior surface of the enclosure 701. The rotation of the second plate 719 and/or the enclosure 701 causes simultaneous rotation of the first end plate 714, spacer plates 713, 718, gear ring 717, enclosure plates 709,716, and support plate 712. The bracket support block 710 may not rotate.

The gear ring 717 can include gear teeth 725b along an inner circumference that can engage with the gear teeth 725a of the gear 705. The gear end plate 715 can include an opening 715a (e.g., a circular opening) that is offset from the longitudinal axis of the gear end plate 715. The opening 715a can extend through an edge of the gear end plate 715. The diameter of the opening 715a can be the outer diameter (i.e., the diameter of the gear measure from the outermost points of the gear teeth 725a across a face of the gear 705) of the gear 705 with an additional tolerance. The blade 702 can rotate either with the blade shaft 703 or relative to the blade shaft 703 depending on how the blade 702 is coupled to the blade shaft 703. This rotation can occur when the gear 705, which is coupled to the blade 702, turns in response to the rotation of the gear ring 717. The gear ring 717 can be driven by its coupling with the second end plate 719, which can be configured to rotate using a rotator chuck assembly (e.g., via shaft 723). In this way, the blade 702 rotates with the rotation of the enclosure 701.

A material can be introduced into the enclosure 701 and the rotation of the enclosure 701 causes the blade 702 to rotate such that an extensional flow and/or shear flow is generated within the gap where the material is disposed. As rotation of the enclosure 701 continues, at least a portion of the material can be wiped on the interior surface of the enclosure 701, forming a coating on the surface of the enclosure 701. The material coating the interior surface of the enclosure 701 can then be reintroduced to the pool of material disposed in the gap with subsequent rotation of the enclosure 701, thereby continuously exposing the material to periodic extensional flow. In this way, the flow-rotation process repeats periodically at a rate determined by the relative rotation between the blade 702 and the enclosure 701. Consequently, the material can undergo continuous exposure to periodic extensional flow and/or shear flow. The flow-rotation process is distinct from other processes, such as spin coating, which can only apply a single extensional flow within a material.

In some implementations, the enclosure 701 and the blade 702 both rotate either at the same speed or at different tangential speeds. The tangential speed may be varied between the enclosure 701 and the blade 702 in a number of ways, including but not limited to, varying the gear ratio between the gear 705 and gear ring 717, which can be achieved by incorporating additional gears between the gear 705 and gear ring 717 (e.g., incorporating a gear train), varying the inner circumference of the gear ring 717, varying the diameter of the gear 705. By way of example, a gear 705 with a greater number of teeth than the gear ring 717 can increase the gear ratio, resulting in a reduction of the speed of the blade 702 relative to the enclosure 701. In some implementations, the enclosure 701 and the blade support arm 702 rotate in the same direction. The variations in rotation speed and rotational direction may allow for different operational dynamics.

A portion (e.g., between the first end 704a and the second end 704b) of the blade support arm 704 can extend through the opening 709a of the first enclosure plate 709, the opening 710a of the bracket support block 710, the spacer plate 713, and the first end plate 714. The first end plate 714 can include an opening that extends through the thickness of the first end plate 714 and through which the blade support arm 704 extends through. A first end 704b of the blade support arm 201 can be coupled to a first mounting plate (e.g., first mounting plate 103). A tip-tilt base plate (e.g., tip-tilt base plate 104) can be coupled (e.g., threadably coupled) to the first mounting plate. The tip-tilt base plate can include a plurality of openings (e.g., openings 307) that each extend through the thickness of the tip-tilt base plate. The plurality of openings can each be sized and shaped to receive a pivot point (e.g., pivot point 306a). Each of the pivot points can extend through a respective opening of the tip-tilt base plate and project beyond the opening such that a distal end of each pivot point makes contact with the first mounting plate. By adjusting one or more pivot points, a pressure or force can be applied against different portions of the first mounting plate, which can cause the plate to tilt accordingly. This adjustment allows angling and positioning of the blade support arm 704 (coupled with the blade shaft 703 and blade 702) within the enclosure 701.

A translation stage (e.g., translation stage 112) can be coupled to the tip-tilt base plate via attachment points on the tip-tilt base plate (e.g., attachment points 305). The translation stage can include a device or system to move the tip-tilt base plate (coupled with the first mounting plate) is it coupled to. The translation stage can move the tip-tilt base plate in one or more directions (e.g., linear paths along x-, y-, and/or z-axis). The stage base of the translation stage can be coupled to a second mounting plate (e.g., second mounting plate 105). The carriage (i.e., the portion of the translation stage that moves along the rail mounted on the stage base) can be coupled to the tip-tilt base plate. The second mounting plate can be coupled (e.g., fixedly coupled) to a base. The second mounting plate can be formed of a material with a high hardness which can reduce deflection during loading.

In some implementations, the periodic extensional flow reactor system can include a cooling system (e.g., air cooling, ventilation, heat sink, liquid cooling). In some implementations, the periodic extensional flow reactor system can include a pressure control system which can include pressure regulators. In some implementations, the periodic extensional flow reactor system includes a monitoring and control system which can include a data acquisition system. In some implementations, the periodic extensional flow reactor system includes a temperature control system which can control the temperature within the enclosure 701. In some implementations, portions (e.g., blade support arm 704, blade 702) of the periodic extensional flow reactor are corrosion resistant. In some implementations, a heating and/or cooling system are disposed within the flow obstacle (e.g., blade 702, blade shaft 703 and/or blade support arm 704). In some implementations, the blade shaft 703 includes a heating rod. The blade shaft 703 can include an opening extending through the thickness of the blade shaft 703 and the heating rod can extend through the opening. The blade support arm 704 can include an opening through which a portion of the heating rod (e.g., cables or wiring of the heating rod) can be routed through. In some implementations, the heating rod can be configured to heat between 150° C. and 300° C. In some implementations, the heating rod can be configured to heat between 180° C. and 250° C. In some implementations, the heating rod can be configured to heat between 100° C. and 150° C. In some implementations, temperature, composition, and/or pressure can be measured from within the flow obstacle.

A material can be introduced into the enclosure 701 via tubing (e.g., tubing 107). The material can be loaded into a syringe and injected through the tubing. In some implementations, a flow control mechanism such as a pump, valve, and/or flow sensor can be attached to the tubing and/or syringe to control and/or modulate the flow of material (e.g., reactants, 2-dimensional polymers, any type of polymer, and/or additives) into the enclosure 701. Tubing may include one or more tubes that can each be routed through an opening 704c extending through the thickness of the blade support arm 704 so that an end of the tubing can extend into the interior volume of the enclosure 701.

Gases (e.g., inert gas, reactive gas, solvent vapor, and/or a combination of gases) can be introduced into the enclosure 701 via tubing (e.g., tubing 109a). Tubing (e.g., tubing 109b) can be used to provide an outlet for gases (e.g., nitrogen gas, trifluoracetic acid (TFA) mixed with water vapor) which can help maintain the proper chemical environment, manage pressure, remove by-products from within the enclosure 701. Tubing (e.g., tubing 109a,b) can be routed through the opening 704c of the blade support arm 704 so that an end of the tubing extends into the interior volume of the enclosure 701. Another end of the tubing for introducing gases (e.g., inert gas, reactive gas, solvent vapor, and/or a combination of gases) into the enclosure 701 can be connected to a mass flow controller (e.g., mass flow controller 110) to regulate the flow of gas.

A position of the flow obstacle can be adjustable (e.g., via adjusting the tip-tilt base plate 104 and/or the translation stage 112) so that the flow obstacle contacts a surface (i.e., the exterior surface or the interior surface) of the enclosure (e.g., enclosure 101, enclosure 701). In some implementations, the flow obstacle does not contact a surface of the enclosure. A gap is defined between the surface of the curved enclosure and the flow obstacle, where a material is disposed.

In some implementations, the blade (e.g., blade 202, blade 702) includes a plurality of blades. In some implementations, the one or more blades rotate around the interior surface of the enclosure (e.g., enclosure 101, enclosure 701). In other implementations, the one or more blades rotate around the exterior surface of the enclosure, in which the gap where extensional flow and/or shear flow is generated within a material is defined between the exterior surface of the enclosure and a surface of the blade. The blades can be the same blade configuration or different blade configurations (e.g., flat, flap, cylindrical). The blades may be smooth or textured. The blades may be stationary or co-rotating with the enclosure. The speed of the one or more blades may be the same or a different tangential speed from the enclosure. A surface of the one or more blades of the plurality of blades may be in contact with the surface of enclosure. One or more blade of the plurality of blades may not be in contact with the surface of the enclosure. One or more blades of the plurality of blades may be attached to a mounting plate, which can include a tip-tilt mechanism (e.g., tip-tilt base plate 104), and/or a translation stage (e.g., translation stage 112). Other types of mechanisms may be included with the mounting plate to enabled adjustment of the blade position (x-, y-, z-, and/or angle of the blade).

In some implementations, the interior of the enclosure can be maintained under vacuum or pressurized conditions. A material introduced into the enclosure can be a fluid. The material may not be introduced into the enclosure via spraying. In some implementations, the enclosure (e.g., enclosure 101, enclosure 701) is stationary, and the flow obstacle rotates, or portions of the flow obstacle rotate (e.g., blade support arm 201 and/or blade 202, or blade support arm 704, blade shaft 703, and/or blade 702). The flow obstacle or portions of the flow obstacle can rotate about their longitudinal axis. In some implementations, both ends of the flow obstacle are each rigidly coupled to a separate mounting plate (e.g., mounting plate 103), tip-tilt mechanism (e.g., tip-tilt base plate 104), and/or translation mechanism (e.g., translation stage 112). The position of the ends of the flow obstacle can be adjustable (e.g., via adjusting the tip-tilt base plate 104 and/or the translation stage 112).

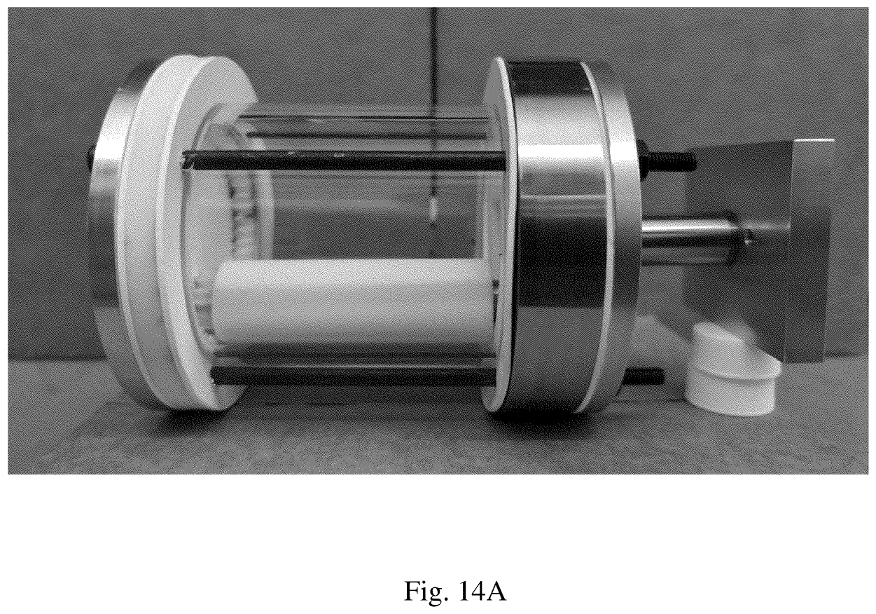

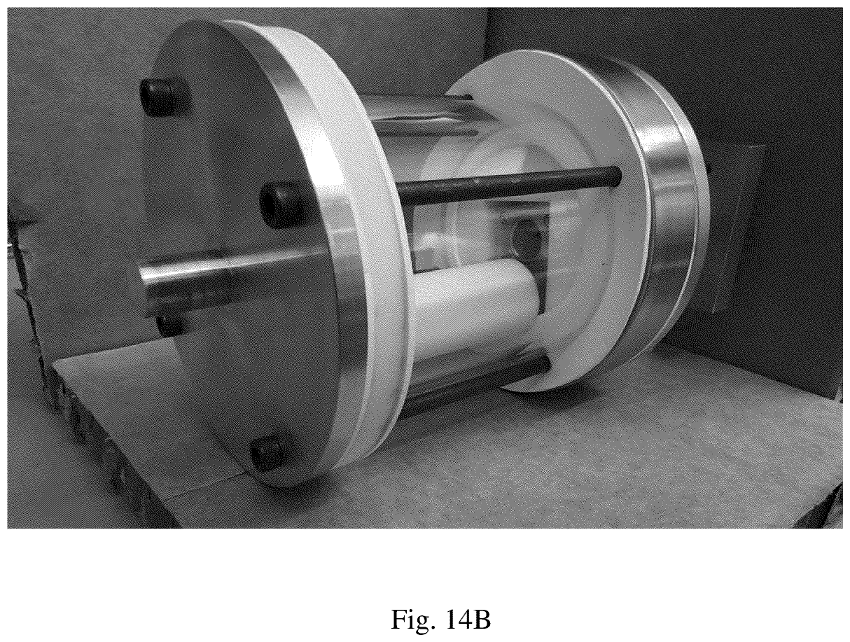

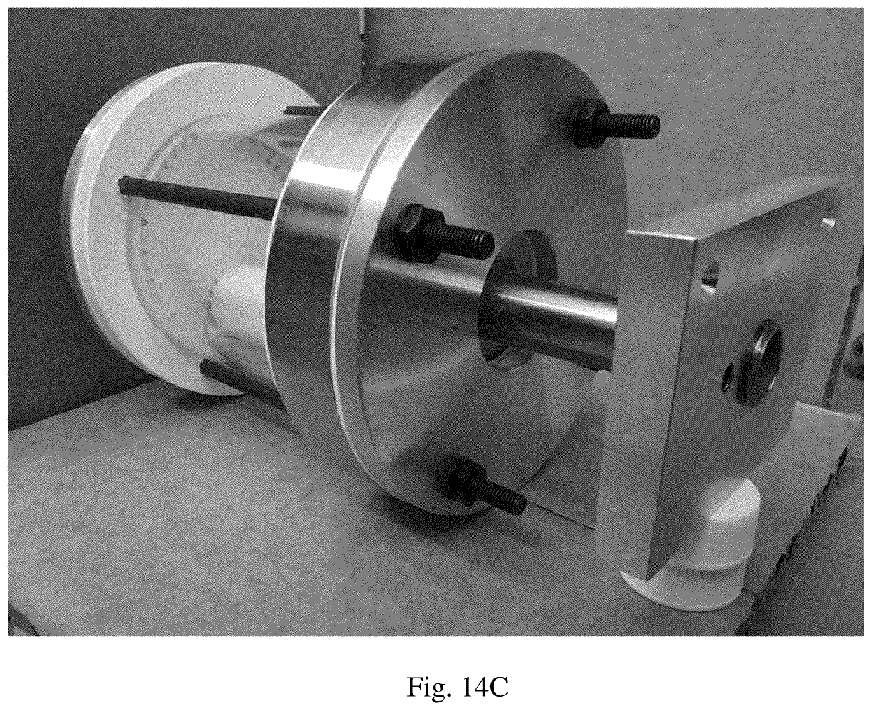

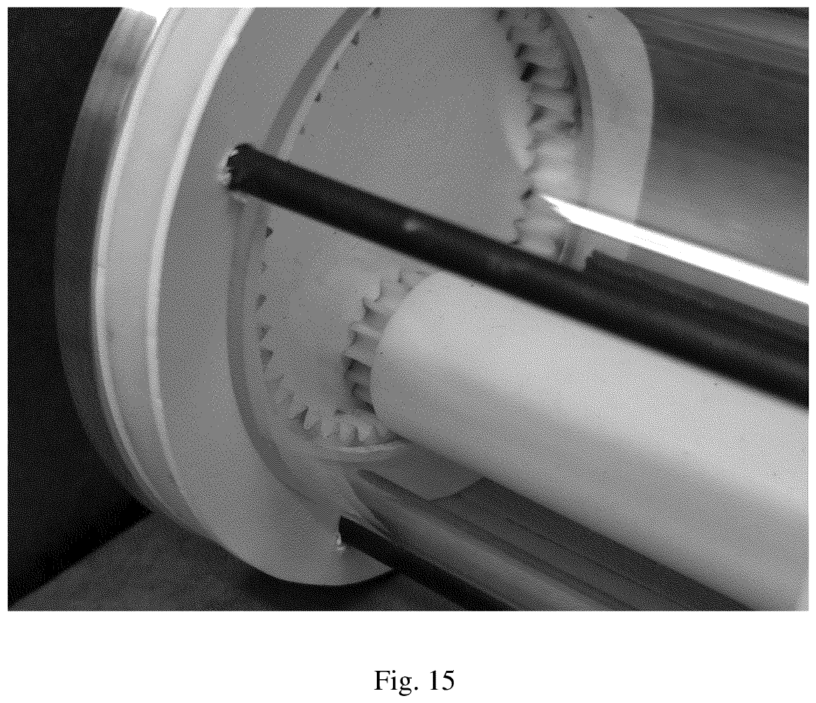

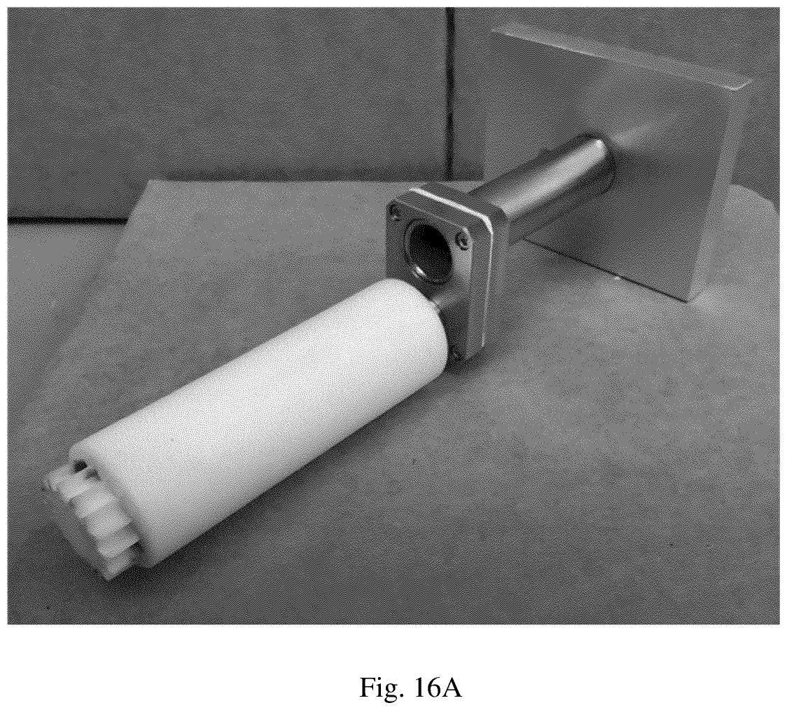

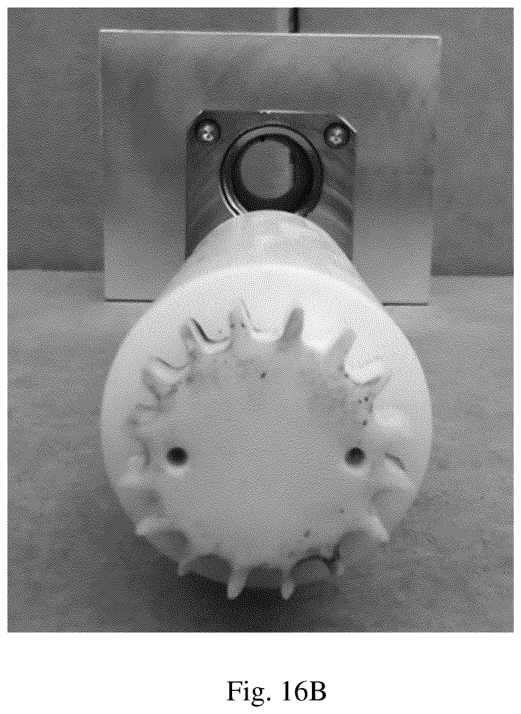

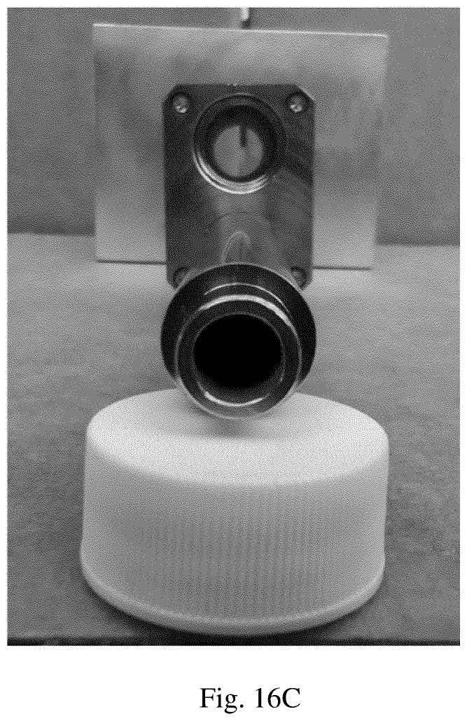

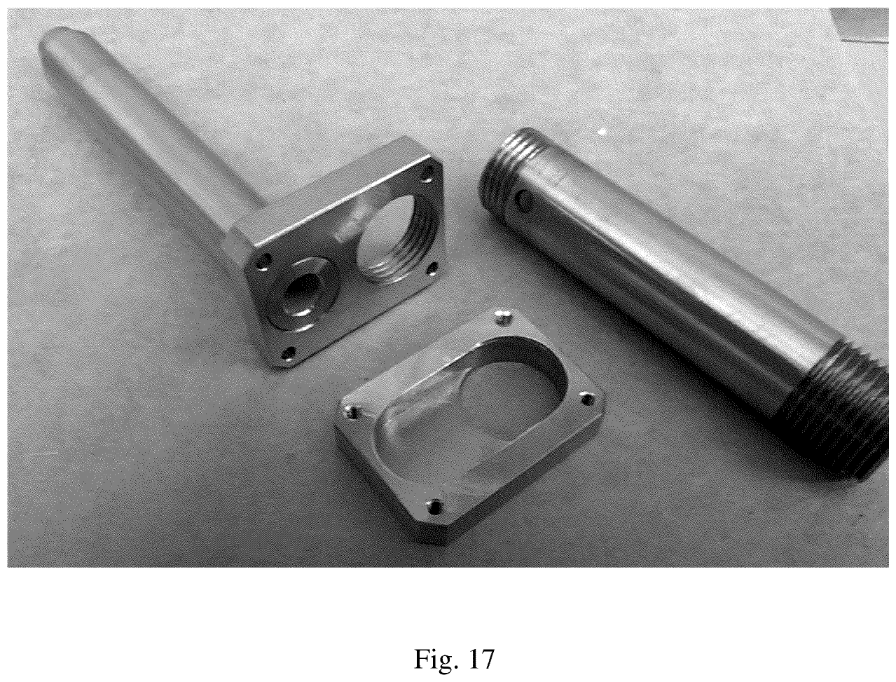

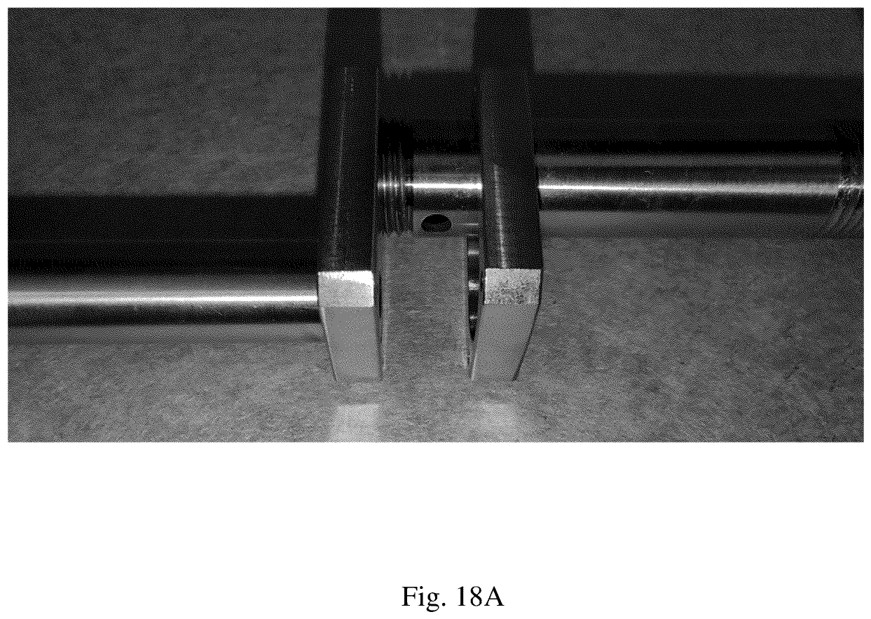

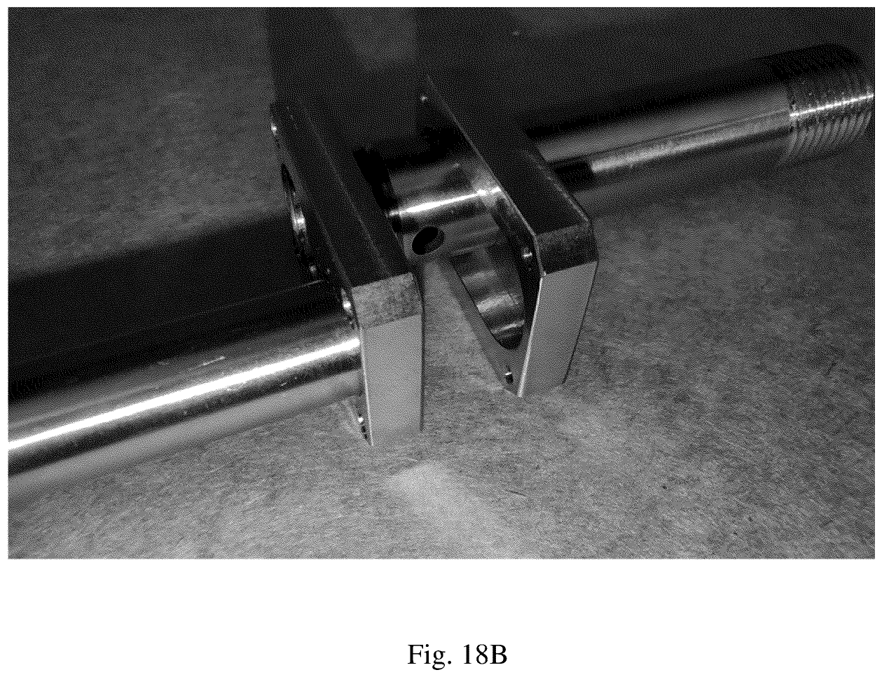

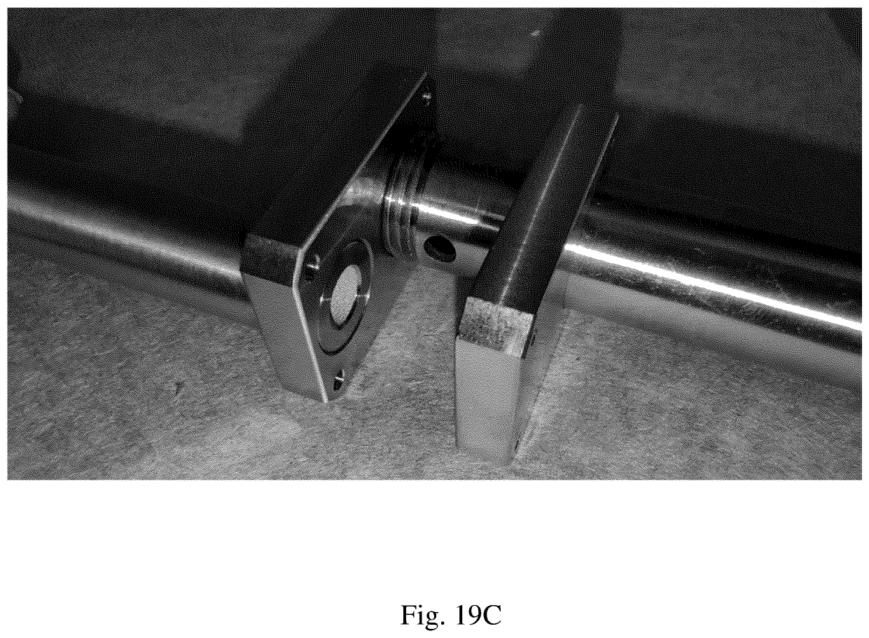

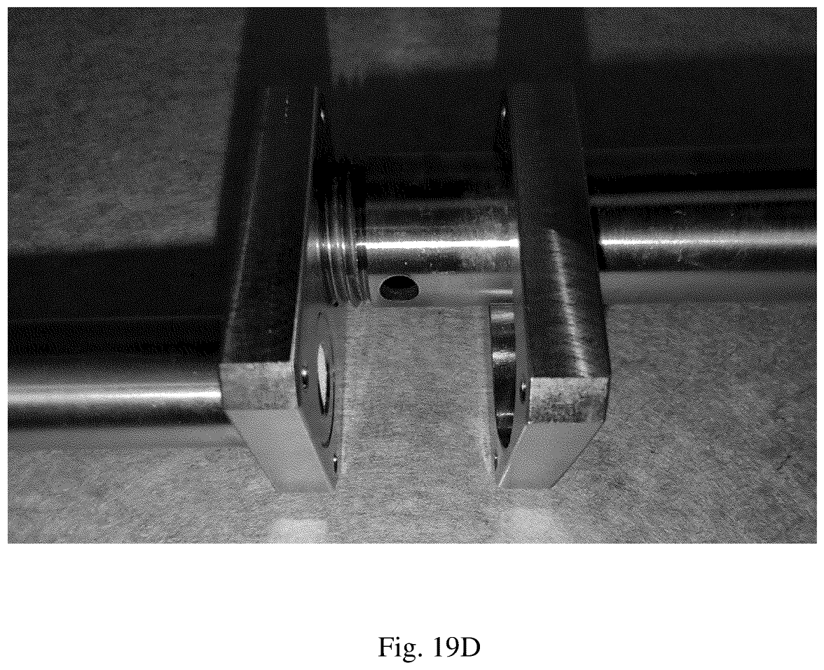

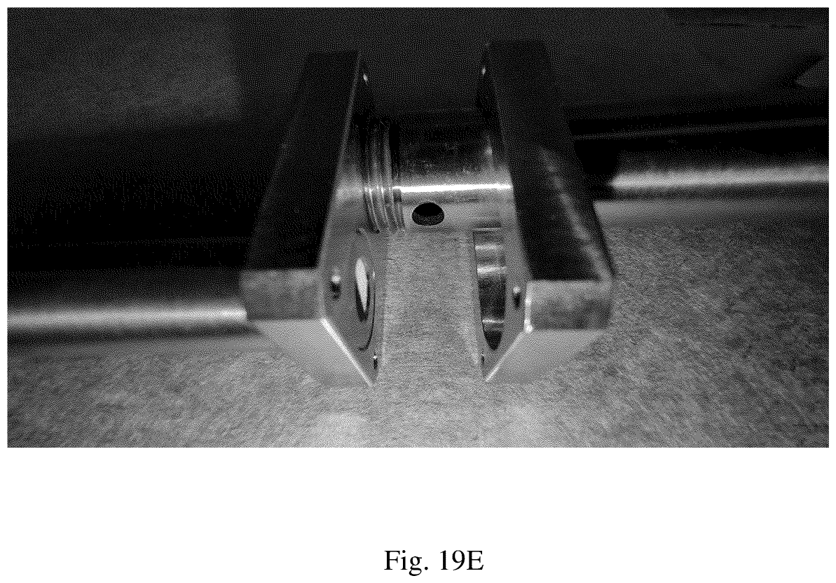

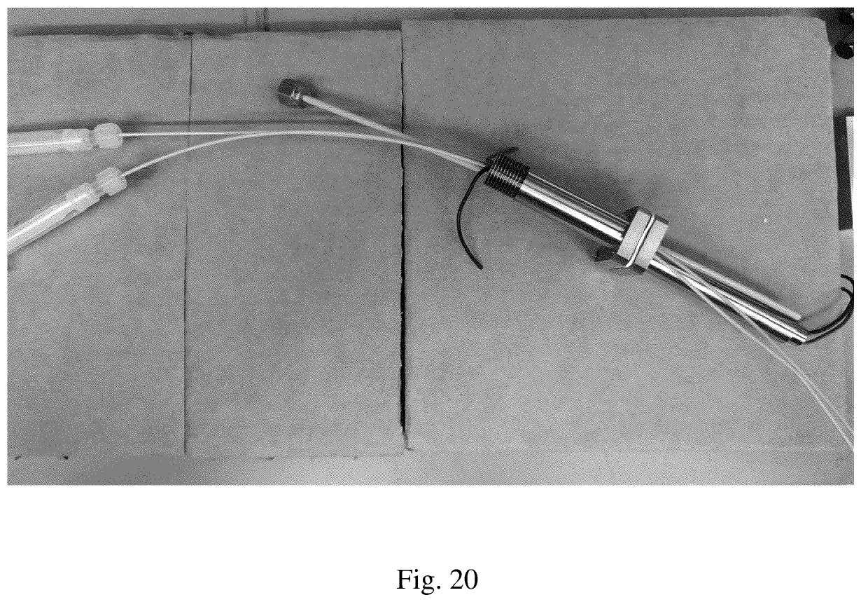

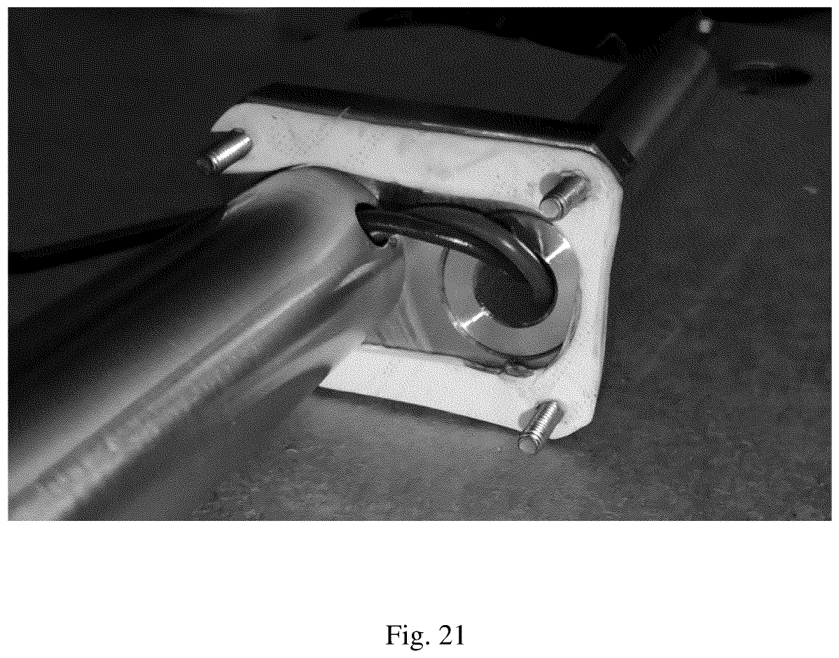

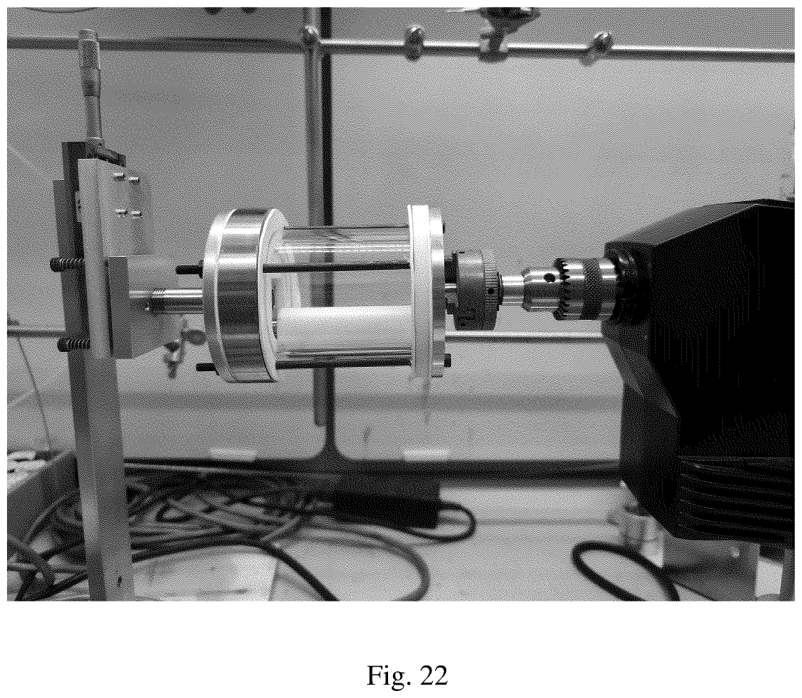

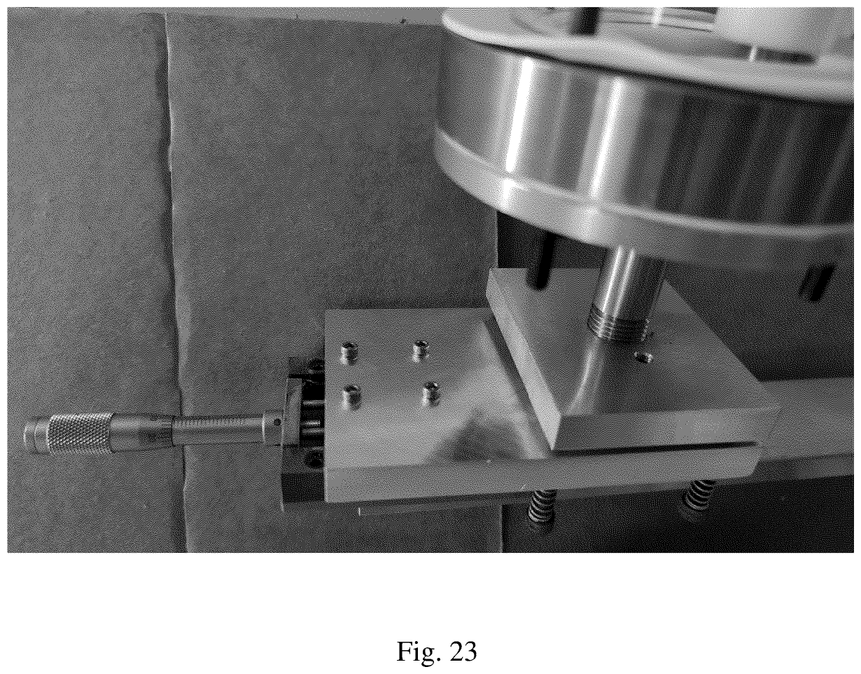

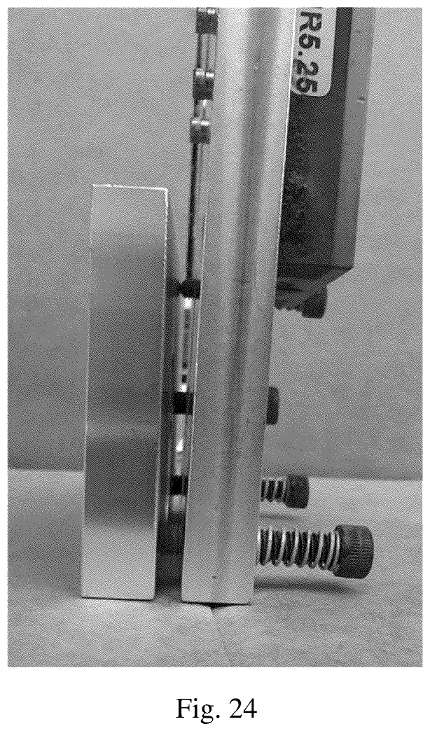

FIGS. 14A-25 show images of different portions of a second implementation of a periodic extensional flow reactor described herein.

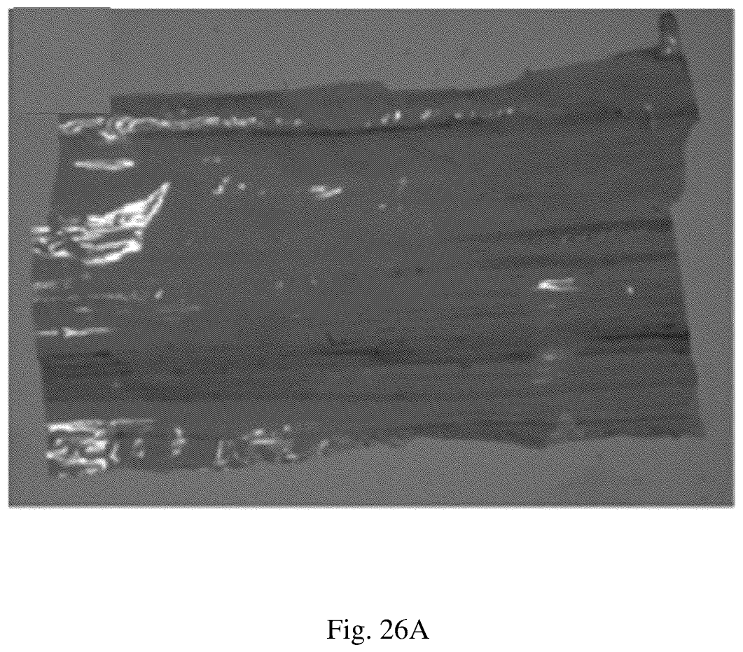

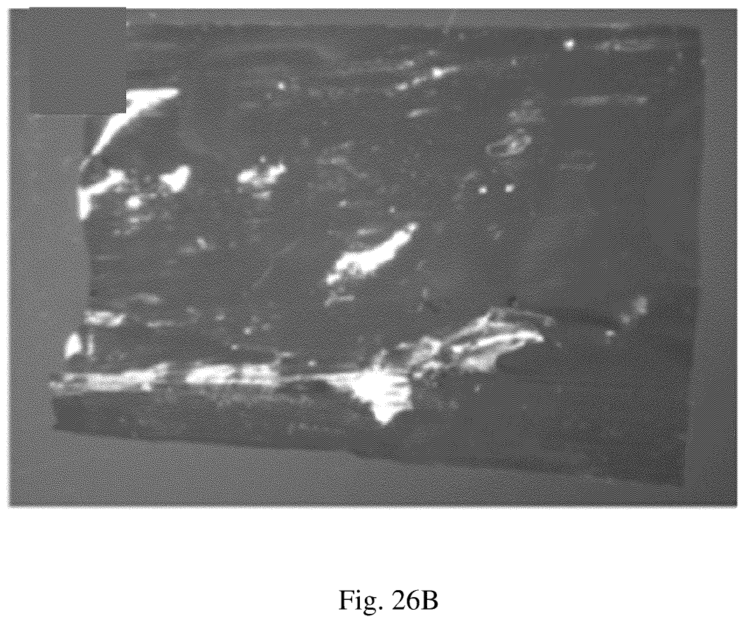

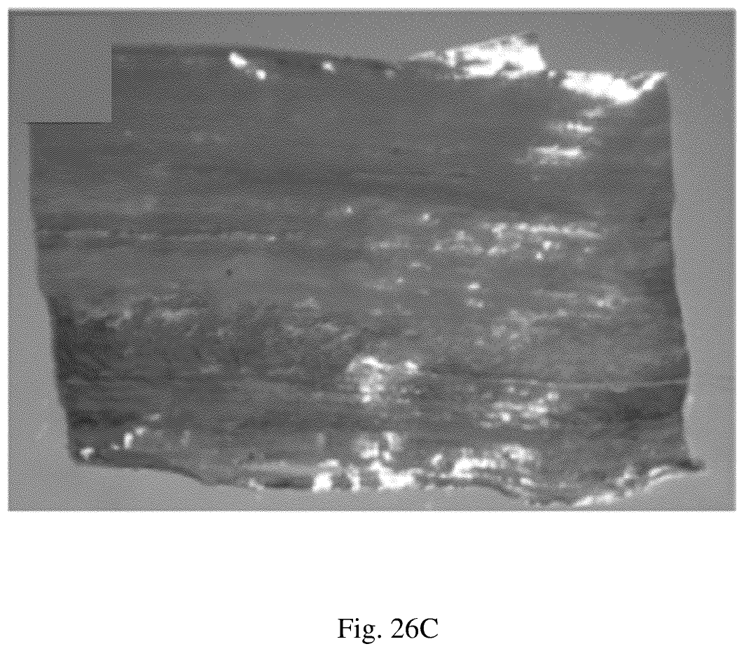

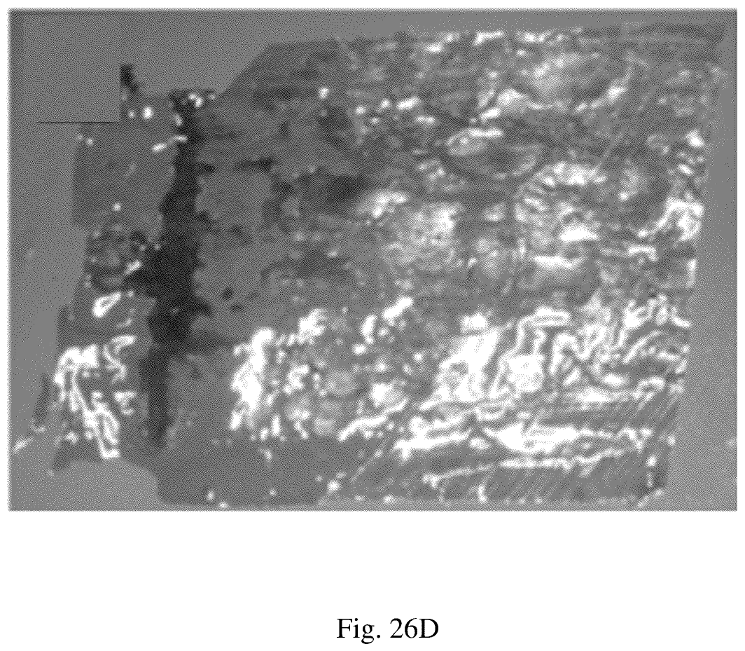

FIGS. 26A-2D show examples of TAPB-PDA films processed under different conditions using a periodic extensional flow reactor as described herein. FIG. 26A shows a TAPB-PDA film produced using 25 mg/mL 2-dimensional polymer (2DP) solution and 95-5 TFA-water solvent. FIG. 26B shows a TAPB-PDA film produced using 12.5 mg/mL 2DP solution, 95-5 TFA-water solvent. FIG. 26C shows a TAPB-PDA film produced using 25 mg/mL 2DP solution, 99-1 TFA-water solvent. FIG. 26D shows a TAPB-PDA film produced using 12.5 mg/mL 2DP solution, 99-1 TFA water solvent.

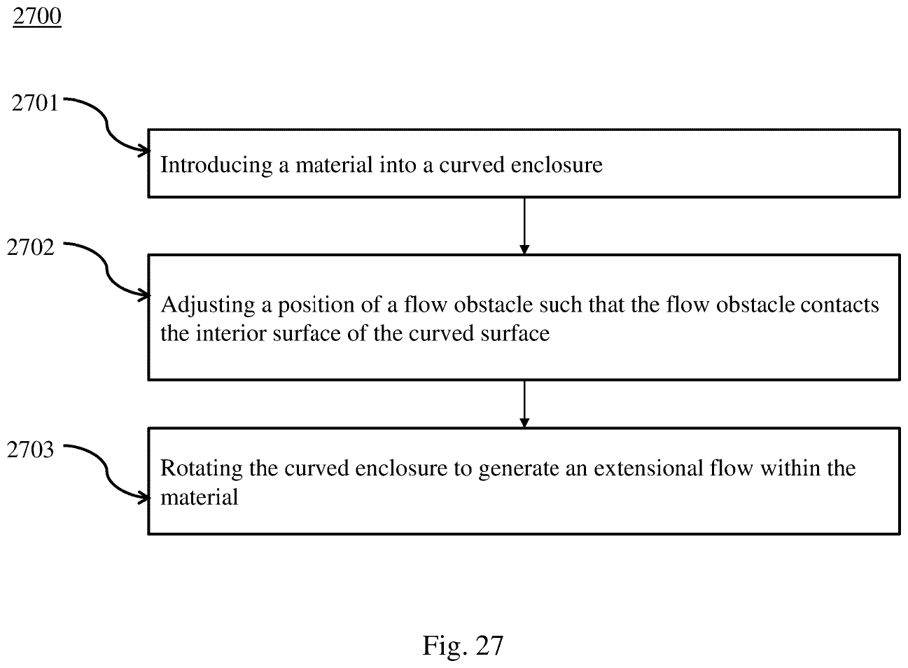

Referring now to FIG. 27, a flow chart depicting a method for producing anisotropic polymer films is shown. A method for producing anisotropic polymer films is provided. At step 2701, a material can be introduced into a curve enclosure. The curved enclosure can have an exterior surface and an interior surface defining an interior volume. An opening at one end of the curved enclosure can extend through the interior volume. At step 2702, a position of a flow obstacle is adjusted such that the flow obstacle contacts the interior surface of the curved enclosure. The flow obstacle can have a first end and second end. The second end of the flow obstacle can extend through the opening and interior volume of the curved enclosure. The first end of the flow obstacle can be rigidly coupled to a mounting plate. At step 2703, the curved enclosure can be rotated to generate an extensional flow within the material. A gap can be defined between the interior surface of the curved enclosure and the flow obstacle. The method for producing anisotropic polymer films can further include solvent drying, crystallization, phase transition, polymerization, other chemical reactions, or a combination thereof to form the polymer films.

The disclosed system may be embodied in other specific forms without departing from the spirit or essential characteristics thereof. The foregoing implementation are therefore to be considered in all respects illustrative, rather than limiting of the invention. Having thus described several illustrative implementation, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one implementation are not intended to be excluded from similar or other roles in other implementations. Additionally, elements and components described herein may be further divided into additional components or joined together to form fewer components for performing the same functions. Accordingly, the foregoing description and attached drawings are by way of example only, and are not intended to be limiting.

1. An apparatus for producing oriented polymer films, comprising:
a curved enclosure having an exterior surface and an interior surface defining an interior volume, wherein an opening extends through the curved enclosure and into the interior volume, the curved enclosure configured to rotate; and
a flow obstacle having a first end and a second end, the second end of the flow obstacle extending through the opening and within the interior volume of the curved enclosure and the first end of the flow obstacle rigidly coupled to a mounting plate, wherein a position of the flow obstacle is adjustable so that the flow obstacle contacts the interior surface of the curved enclosure;
wherein a gap is defined between the interior surface of the curved enclosure and the flow obstacle, where a material is disposed.

2. The apparatus of claim 1, wherein the curved enclosure is flushed with inert gas.

3. The apparatus of claim 2, wherein the inert gas is nitrogen.

4. The apparatus of claim 1, wherein the curved enclosure comprises a heat transfer system, the heating system including an insulator, a conductor, and a layer for heating, cooling, or a combination thereof.

5. The apparatus of claim 1, wherein the material is a two-dimensional polymer.

6. The apparatus of claim 1, wherein the material is a phase changing system, a reacting system, or a combination thereof that produces a polymer.

7. The apparatus of claim 1, wherein a continuous rotation of the curved enclosure generates a periodic extensional flow within the material.

8. The apparatus of claim 1, wherein the curved enclosure is a cylindrical enclosure.

9. The apparatus of claim 1, wherein the internal flow obstacle comprises a blade support arm connected to a blade.

10. The apparatus of claim 9, wherein the blade is a flap blade.

11. The apparatus of claim 9, wherein the blade is a cylindrical blade.

12. The apparatus of claim 9, wherein the blade is fixedly coupled to the blade support arm.

13. The apparatus of claim 1, wherein the blade is rotatably coupled to the blade support arm and the blade rotates in response to a rotation of the curved enclosure.

14. The apparatus of claim 1, wherein an extensional flow is generated in the material.

15. The apparatus of claim 1, wherein a shear flow is generated in the material.

16. The apparatus of claim 1, wherein a plurality of flows is generated in the material, and wherein the plurality of flows is laminar, turbulent, or a combination thereof.

17. The apparatus of claim 1, wherein the blade is a plurality of blades.

18. The apparatus of claim 1, wherein the mounting plate includes a tip-tilt base plate, a translation stage, or a combination thereof.

19. An apparatus for producing oriented polymer films, comprising:
a curved enclosure having a surface; and
a flow obstacle having a first end and a second end, the second end of the flow obstacle extending over the surface of the curved enclosure and the first end of the flow obstacle rigidly coupled to a mounting plate, wherein a position of the flow obstacle is adjustable so that the flow obstacle contacts the surface of the curved enclosure;
wherein a gap is defined between the surface of the curved enclosure and the flow obstacle, where a material is disposed.

20. A method of producing oriented polymer films comprising:
introducing a material into a curved enclosure, the curved enclosure having an exterior surface and an interior surface defining an interior volume, wherein an opening extends through the curved enclosure and into the interior volume;
adjusting a position of a flow obstacle such that the flow obstacle contacts the interior surface of the curved enclosure, the flow obstacle having a first end and a second end, the second end of the flow obstacle extending through the opening and within the interior volume of the curved enclosure and the first end of the flow obstacle rigidly coupled to a mounting plate; and
rotating the curved enclosure to generate an extensional flow within the material;
wherein a gap is defined between the interior surface of the curved enclosure and the flow obstacle, where the material is disposed.

21. The method of claim 20, introducing the material into the curved enclosure further comprising injecting the material into the curved enclosure.

22. The method of claim 20, introducing the material into the curved enclosure comprising introducing a two-dimensional polymer into the curved enclosure.

23. The method of claim 20, rotating the curved enclosure comprising rotating the curved enclosure such that the material undergoes periodic extensional flow.

24. The method of claim 20, further comprising flushing the curved enclosure with an inert gas.

25. The method of claim 20, rotating the curved enclosure further comprising rotating a portion of the flow obstacle, wherein the flow obstacle comprises a blade rotatably coupled to a blade support arm and the blade rotates in response to a rotation of the curved enclosure.

26. The method of claim 25, wherein the blade is a cylindrical blade.

27. An apparatus for producing oriented polymer films, comprising:
a curved enclosure having a surface; and
a flow obstacle having a first end and a second end, the flow obstacle extending over the surface of the curved enclosure and the first end and second end of the flow obstacle each rigidly coupled to a mounting plate, wherein a position of the flow obstacle is adjustable so that the flow obstacle contacts the surface of the curved enclosure;
wherein a gap is defined between the surface of the curved enclosure and the flow obstacle, where a material is disposed.

28. The apparatus of claim 27, wherein the curved enclosure rotates.

29. An apparatus for producing oriented polymer films, comprising:
a curved enclosure having a surface; and
a flow obstacle having a first end and a second end, the flow obstacle extending over the surface of the curved enclosure and the first end and second end of the flow obstacle each rigidly coupled to a mounting plate, wherein a position of the flow obstacle is adjustable;
wherein a gap is defined between the surface of the curved enclosure and the flow obstacle, where a material is disposed.

30. The apparatus of claim 29, wherein the curved enclosure rotates.

31. The apparatus of claim 29, wherein the blade is a plurality of blades.

32. The apparatus of claim 29, wherein the mounting plate includes a tip-tilt base plate, a translation stage, or a combination thereof.
